(19) United States
(12) Patent Application Publication
(10) Pub. No.: US 2019/0220162 A1
(43) Pub. Date: Jul. 18, 2019

(54) METHOD AND SYSTEM OF CONTEXT-BASED VISUAL CUE MANAGEMENT FOR CONTENT

(71) Applicant: Samsung Electronics Co., Ltd., Suwon-si (KR)

(72) Inventors: Poshith UDAYASHANKAR, Bangalore (IN); Nikhil MESHRAM, Maharashtra (IN)

(21) Appl. No.: 16/252,343

(22) Filed: Jan. 18, 2019

(30) Foreign Application Priority Data
Jan. 18, 2018 (IN) 201841002083

(51) Int. Cl. G06F 3/0485; G06F 3/0481

(52) U.S. Cl. CPC G06F 3/0485; G06F 3/04883; G06F 3/0481

(57) ABSTRACT

Embodiments herein provide a method for providing context-based visual cue in an electronic device. The method includes detecting an event while a user is scrolling a content. Further, the method includes dynamically determining a context of the content based on a scrolling pattern of the content. Furthermore the method includes causing to display a visual cue based on the context of the content. The proposed method can be used to display the visual cue based on the context of the content, where the visual cue is displayed in a direction of scrolling of the content. Further, the visual cue includes recommendations which are contextually related to the content. The proposed method can be used to dynamically determine the context of the content based on the scrolling pattern and interaction pattern of the content. This results in improving the user experience.

### CROSS-REFERENCE TO RELATED APPLICATIONS

This application is based on and claims priority under 35 U.S.C. § 119 to Indian Patent Application No. 201841002083 filed on Jan. 18, 2018 in the Indian Patent Office, the disclosure of which is incorporated by reference herein in its entirety.

### BACKGROUND

### 1. Field

The present disclosure relates to a recommendation system, and more specifically to a method and system of context-based visual cue management for a content.

### 2. Description of Related Art

Technologies related to a touch screen display are rapidly growing. An electronic device provides a content (e.g., large text document, list item, graphical icon, or the like) on a display area of the touch screen display. In order to view the content fully, a user needs to perform an operation (e.g., scroll operation, swipe operation or the like) on the display area of the touch screen display. Further, the user may not know that whether an end of the content is reached or not.

There are a lot of existing methods in which the electronic device can provide a feedback, (e.g., a visual, a tactile, an audible, etc.) when the user reaches the end of the content being displayed in the touch screen display. However, there are cases in which the user may not be able to find the content (e.g., desired/interested content) even after reaching the end of the content.

In one existing method, when the user performs the operation (e.g., scroll operation or the like) and reaches the end of the content, the electronic device provides a visual indication on the touch screen display. The visual indication provides a message saying that ‘no more content available for you’. However, the method reduces the user experience, as the user is not able to find the interested content even after reaching the end of the content.

For example, a gallery application may be executed in the electronic device, in which the user is scrolling through a plurality of images displayed on the touch screen display. Further, when the user reaches a last image in the gallery application, the visual indication (such as ‘no more image available for you’ may be provided. However, the user may not able to find a desired image even after reaching the end of the image in the gallery application.

In another existing method, when the user performs the operation (e.g., scroll operation or the like) and reaches the end of the content displayed on the electronic device, the electronic device may provide recommendations as a pop-up advertisement or a notification in the touch screen display. Further, the pop-up advertisement or the notification will disappear after a predetermined time. Hence, there may be a chance to miss the recommendations (includes user interested content), when the recommendations appear as the pop-up advertisement in the touch screen display of the electronic device.

For example, when the user performs scrolling the content (e.g., article) on a web browser application executed in the electronic device. If the user reaches the end of the content then, the electronic device may provide the recommendations (e.g., user interested content) as the pop-up advertisement for at most one minute. However, there may have the chance for the user to miss the recommendation which appeared for the one minute.

### SUMMARY

The principal object of the embodiments herein is to provide a method and system of context-based visual cue management for a content.

Another object of the embodiments herein is to dynamically determine a context of the content based a scrolling pattern of the content.

Another object of the embodiments herein is to determine the scrolling pattern of the content based on an interaction pattern of a user with a portion of the content while scrolling through the content.

Another object of the embodiments herein is to dynamically determine the interaction pattern based on a speed of scrolling the content.

Another object of the embodiments herein is to dynamically determine the interaction pattern based on a time spent by the user on the portion of the content while scrolling the content.

Another object of the embodiments herein is to dynamically determine the interaction pattern based on a filter used while scrolling the content.

Another object of the embodiments herein is to determine the scrolling pattern of the content based on an interaction pattern of the content of at least one application.

Another object of the embodiments herein is to determine the scrolling pattern of the content based on a switching pattern between the at least one application and at least one other application in an electronic device.

Another object of the embodiments herein is to dynamically determine the switching pattern based on a type of action performed by the user for the portion of the content while scrolling the content.

Another object of the embodiments herein is to dynamically determine the switching pattern based on the other application running at the electronic device.

Another object of the embodiments herein is to dynamically determine the switching pattern based on a user intent.

Another object of the embodiments herein is to determine the scrolling pattern of the content based on the context of the at least one application.

Another object of the embodiments herein is to determine the context of the at least one application based on determining a domain of the at least one application.

Another object of the embodiments herein is to determine the context of the at least one application based on features supported by the at least one application.

Another object of the embodiments herein is to determine the context of the at least one application based on linked apps with the at least one application.

Another object of the embodiments herein is to determine the context of the at least one application based on the content supported by the at least one application.

Another object of the embodiments herein is to determine the context of the at least one application based on the user intent associated with the at least one application.

Another object of the embodiments herein is to determine the context of the at least one application based on a user interaction pattern with the at least one application.

Another object of the embodiments herein is to detect a direction of scrolling of the content of the at least one application.

Another object of the embodiments herein is to generate a visual cue includes a recommendation of at least one key element contextually related to the content.

Another object of the embodiments herein is to cause to display the visual cue in the direction of scrolling of the content.

Accordingly the embodiments herein provide a method for providing context-based visual cue in an electronic device. The method includes detecting an event while a user is scrolling a content. Further, the method includes dynamically determining a context of the content based on a scrolling pattern of the content. Furthermore the method includes causing to display a visual cue based on the context of the content.

In an embodiment, the event indicates at least one of an end of the content in at least one application is reached while the user is scrolling the content, an end of the content in the at least one application is about to reach while the user is scrolling the content, and a temporary stop on at least one portion of the content while the user is scrolling the content.

In an embodiment, the visual cue includes a recommendation of at least one key element corresponding to the content, wherein the at least one key element is contextually related to the content.

In an embodiment, the at least one key element is operable by the user for at least one of dynamically filtering the content of the at least one application, dynamically associating at least one portion of the content of the at least one application with other application in the electronic device, and dynamically operating other application in the electronic device.

In an embodiment, dynamically determining the context of the content based on the scrolling pattern of the content includes determining the scrolling pattern of the content of the at least one application based on at least one of an interaction pattern of the user with at least one portion of the content while scrolling the content, an interaction pattern of the content of the at least one application, a switching pattern between the at least one application and at least one other application in the electronic device, and a context of the at least one application and determining the context of the content of the at least one application based on the scrolling pattern.

In an embodiment, the interaction pattern is dynamically determined based on a speed of scrolling the content, a time spent by the user on the at least one portion of the content while scrolling the content, and a filter used while scrolling the content.

In an embodiment, the switching pattern is dynamically determined based on a type of action performed by the user for the at least one portion of the content while scrolling the content, other application running at the electronic device, and a user intent.

In an embodiment, the context of the at least one application is determined by determining a domain of the at least one application, features supported by the at least one application, linked apps with the at least one application, the content supported by the at least one application, a user intent associated with the at least one application, a user interaction pattern with the at least one application.

In an embodiment, causing to display the visual cue based on the context of the content includes detecting a direction of scrolling of the content of the at least one application and displaying the visual cue in the direction of scrolling of the content.

In an embodiment, a user interface of the visual cue is displayed at a portion of a user interface of the at least one application corresponding to a position of the content at which the event is detected.

Accordingly the embodiments herein provide a method for providing context based visual cue in an electronic device. The method includes detecting a direction of scrolling of a content in at least one application. Further, the method includes generating a visual cue comprising a recommendation of at least one key element contextually related to the content. Furthermore, the method includes causing to display the visual cue in the direction of the scrolling of the content.

In an embodiment, generating the visual cue comprising the recommendation of the at least one key element contextually related to the content includes detecting an event while a user is scrolling the content in the at least one application, dynamically determining a context of the content based on a scrolling pattern of the content and generating the visual cue comprising the recommendation of the at least one key element based on the context of the content.

Accordingly the embodiments herein disclose an electronic device for providing context based visual cue. The electronic device includes a visual cue controller operably coupled to a memory and a processor. The visual cue controller is configured for detecting an event while a user is scrolling a content. Further, the visual cue controller is configured for dynamically determining a context of the content based on a scrolling pattern of the content. Furthermore, the visual cue controller is configured for causing to display a visual cue based on the context of the content.

Accordingly the embodiments herein disclose an electronic device for providing context based visual cue. The electronic device includes a visual cue controller operably coupled to a memory and a processor. The visual cue controller is configured for detecting a direction of scrolling of a content in at least one application. Further, the visual cue controller is configured for generating a visual cue comprising a recommendation of at least one key element contextually related to the content. Furthermore, the visual cue controller is configured for causing to display the visual cue in the direction of the scrolling of the content.

Accordingly the embodiments herein provide a method for providing context based visual cue in an electronic device. The method includes detecting a direction of scrolling of a content in at least one application. The content is scrolled vertically. Further, the method includes determining whether a user reaches an end of the content in the at least one application. Further, the method includes dynamically generating a visual cue including a recommendation of at least one key element contextually related to the content in the at least one application. Furthermore, the method includes causing to display the visual cue along the direction of the scrolling of the content in the at least one application.

Accordingly the embodiments herein provide an electronic device for providing context based visual cue. The electronic device includes a visual cue controller coupled to a memory and a processor. The visual cue controller is configured to detect a direction of scrolling of a content in at least one application. The content is scrolled vertically. Further, the visual cue controller is configured to determine whether a user reaches an end of the content in the at least one application. Further, the visual cue controller is configured to dynamically generate a visual cue including a recommendation of at least one key element contextually related to the content in the at least one application. Further, the visual cue controller is configured to display the visual cue along the direction of the scrolling of the content in the at least one application.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1A and FIG. 1B illustrate examples in which a visual cue is displayed in a direction of scrolling of a content in a gallery application executed in an electronic device, based on detecting that a user reaches an end of the content on the gallery application, according to an embodiment as disclosed herein;

FIG. 2 illustrates a block diagram of various hardware components of the electronic device, according to an embodiment as disclosed herein;

FIG. 3 illustrates a block diagram of various hardware components of a visual cue controller, according to an embodiment as disclosed herein;

FIG. 4A illustrates a flow diagram of various operations for displaying the visual cue by detecting an event while scrolling the content, according to an embodiment as disclosed herein;

FIG. 4B illustrates a flow diagram of various operations for displaying the visual cue by detecting the direction of scrolling of the content, according to an embodiment as disclosed herein;

FIG. 5 illustrates an example flow diagram of various operations performed after displaying the visual cue on a display of the electronic device, according to an embodiment as disclosed herein;

FIGS. 6A-6D illustrate examples in which the visual cue is displayed at the end of a web browser application executed in the electronic device, based on determining that the user reaches the end of the web browser application, according to an embodiment as disclosed herein;

FIGS. 7A-7C illustrate examples in which the visual cue is displayed in the direction of scrolling of the content in a voice recorder application executed in the electronic device, based on determining that the user reaches the end of the content on the voice recorder application, according to an embodiment as disclosed herein;

FIGS. 8A-8C illustrate examples in which the visual cue is displayed in the direction of scrolling of the content in a home application executed in the electronic device, based on detecting that the user reaches the end of the content on the application, according to an embodiment as disclosed herein;

FIG. 9A and FIG. 9B illustrate examples in which the visual cue is displayed at the end of a file manager application associated with the electronic device, based on determining an interaction pattern (i.e., usage history) of the content on the file manager application, according to an embodiment as disclosed herein;

FIG. 10A and FIG. 10B illustrate examples in which the visual cue is displayed at the end of the content in a calendar application executed in the electronic device, based on detecting that the user reaches the end of the content on the calendar application, according to an embodiment as disclosed herein;

FIG. 11A and FIG. 11B illustrate examples in which the visual cue is displayed at the end of the content in a reminder application executed in the electronic device, based on determining the context of the reminder application (e.g., linked apps with the reminder application), according to an embodiment as disclosed herein;

FIGS. 12A-12C illustrate examples in which the visual cue is displayed at the end of the content in the reminder application executed in the electronic device, based on determining the switching pattern of the content on the reminder application, according to an embodiment as disclosed herein;

FIGS. 13A-13D illustrate examples in which the visual cue is displayed in the direction of scrolling of the content in the gallery application executed in the electronic device, based on detecting that the user reaches the end of the content on the gallery application, according to an embodiment as disclosed herein;

FIGS. 14A-14D illustrate examples in which the visual cue is displayed in the direction of scrolling of the content in the home application executed in the electronic device, based on detecting that the user reaches the end of the content on the home application, according to an embodiment as disclosed herein;

FIGS. 15A-15C illustrate examples in which the visual cue is displayed in the direction of scrolling of the content in the gallery application executed in the electronic device, based on detecting that the user reaches the end of the content on the gallery application, according to an embodiment as disclosed herein;

FIGS. 16A-16C illustrate examples in which the visual cue is displayed in the direction of scrolling of the content in the calendar application executed in the electronic device, based on determining the usage history of the content on the calendar application, according to an embodiment as disclosed herein;

FIGS. 17A-17C illustrate examples in which the visual cue is displayed at the end of the content in a clock application executed in the electronic device, based on detecting that the user reaches the end of the content on the clock application, according to an embodiment as disclosed herein;

FIGS. 18A-18D illustrate examples in which the visual cue is displayed at the end of the content on a settings application executed in the electronic device, based on detecting that the user reaches the end of the settings application, according to an embodiment as disclosed herein;

FIGS. 19A-19C illustrate examples in which visual cue is displayed at the end of the content on a weather application executed in the electronic device, based on detecting that the user reaches the end of the weather application, according to an embodiment as disclosed herein;

FIGS. 20A-20D illustrate examples in which the visual cue is displayed at the end of the content on the web browser application executed in the electronic device, based on detecting that the user reaches the end of the web browser application, according to an embodiment as disclosed herein; and

FIG. 21A and FIG. 21B illustrate examples in which the visual cue is displayed in the direction of scrolling of the content in a video application executed in the electronic device, based on detecting a temporary stop on the content in the video application, according to an embodiment as disclosed herein.

### DETAILED DESCRIPTION

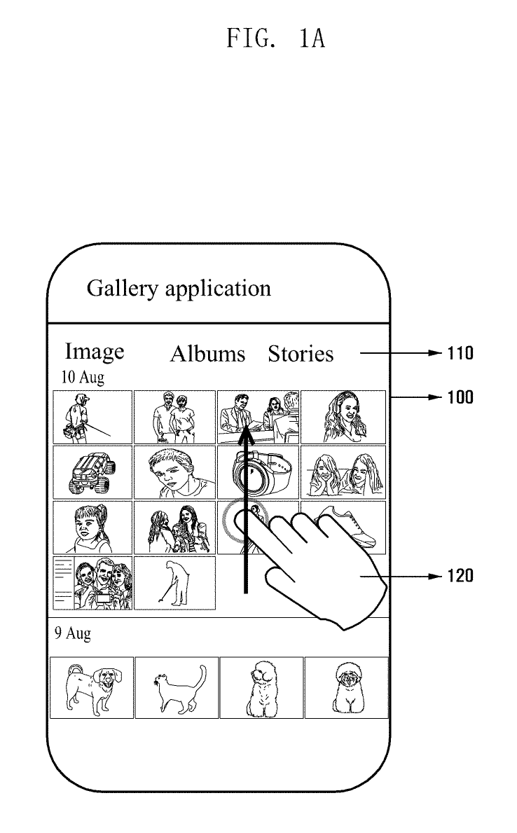

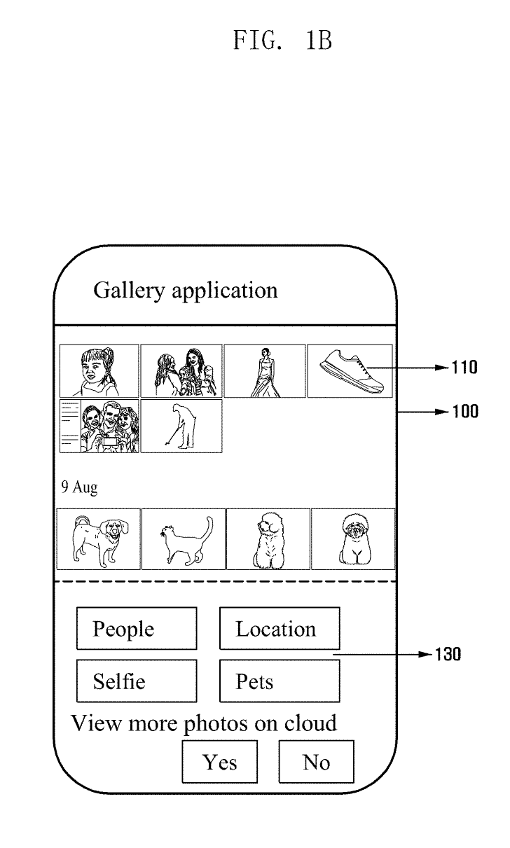

FIGS. 1A through 21B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments herein provide a method for providing context-based visual cue in an electronic device. The method includes detecting an event while a user is scrolling a content. Further, the method includes dynamically determining a context of the content based on a scrolling pattern of the content. Furthermore the method includes causing to display a visual cue based on the context of the content.

Unlike conventional systems and methods, the proposed method can be used to display the visual cue based on the context of the content, where the visual cue is displayed in a direction of scrolling of the content. Further, the visual cue includes recommendations which are contextually related to the content. The proposed method can be used to dynamically determine the context of the content based on the scrolling pattern of the content. This results in improving the user experience.

The proposed method can be used to determine the scrolling pattern of the content of the application based on an interaction pattern of the user with the content of the application, while scrolling through the content. This results in providing recommendations based on determining the interaction pattern of the user in an improved manner.

The proposed method can be used to determine the scrolling pattern of the content of the application based on an interaction pattern of content of the application. This results in providing the recommendation based on determining the interaction pattern of the content of the application user in an effective manner.

The proposed method can be used to determine the scrolling pattern of the content of the application based on a switching pattern between one application and other application in the electronic device. This results in providing the recommendation based on determining the switching pattern between applications in an enhanced manner.

The proposed method can be used to determine the scrolling pattern of the content of the application based on the context of the at least one application. This results in providing the recommendation based on determining the context of the application in an improved manner. The proposed method can be used to provide the recommendation/suggestions for seamless experience within or across the application.

In the proposed method, a visual feedback being replaced by intelligent functions triggered by the gesture at an end of the page. This results in providing the recommendation/suggestions for the seamless user experience within or across the applications.

For example, consider a scenario, in which the user performs a gesture (e.g., scroll gesture or any other gesture) on images of the gallery application. Based on the proposed method, the electronic device determines that the user is about to reach the end of the image in the gallery application. The proposed method can be used to determine the context of the image on the gallery application based on the scrolling pattern associated with the image. Furthermore, the proposed method can be used to display the visual cue at the end of the gallery application, where the visual cue is determined based on the context of the image (e.g., the visual cue includes the recommendation such as a filter for viewing the images in the gallery application). This results in improving the user experience, as a search-ability of the images in the gallery application is optimized.

Referring now to the drawings, and more particularly to FIGS. 1A through 21B, there are shown preferred embodiments.

FIG. 1A and FIG. 1B illustrate examples in which a visual cue is displayed in a direction of scrolling of a content in a gallery application executed in an electronic device 100, based on detecting that a user reaches an end of the content on the gallery application, according to an embodiment as disclosed herein. The electronic device 100 can be, for example, but not limited to, a mobile phone, a smartphone, a laptop, a desktop computer, Personal Digital Assistants (PDAs), a tablet, a phablet, or any other electronic device.

The user performs a gesture 120 (e.g., scroll gesture) on the content of an application browsed in the electronic device 100. The gesture 120 can be, but not limited to, a swipe gesture, a scroll gesture, a sliding gesture, a hand-over gesture, a touch event, a gaze event and the like. The application can be, but not limited to, a web browser application, the gallery application, a home application, a reminder application, a calendar application, a video application, a weather application, a clock application, a file manager application, a voice recorder application, a home screen application, a settings application and the like.

For example, as shown in the FIG. 1A, the user performs the gesture 120 (e.g., scroll gesture) on the gallery application of the electronic device 100.

In response to the gesture 120, the electronic device 100 is configured to detect an event, when the user is scrolling the content in the application. The scrolling can be a vertical scrolling, a horizontal scrolling, a top-to-bottom scrolling, a bottom-to-top scrolling, a right-to-left scrolling, a left-to-right scrolling or the like.

In an embodiment, the event indicates an end of the content in the application is reached, while the user is scrolling the content (as shown in FIGS. 1A and 1B).

In an embodiment, the event indicates that the user is about to reach the end of the content in the application, while scrolling the content.

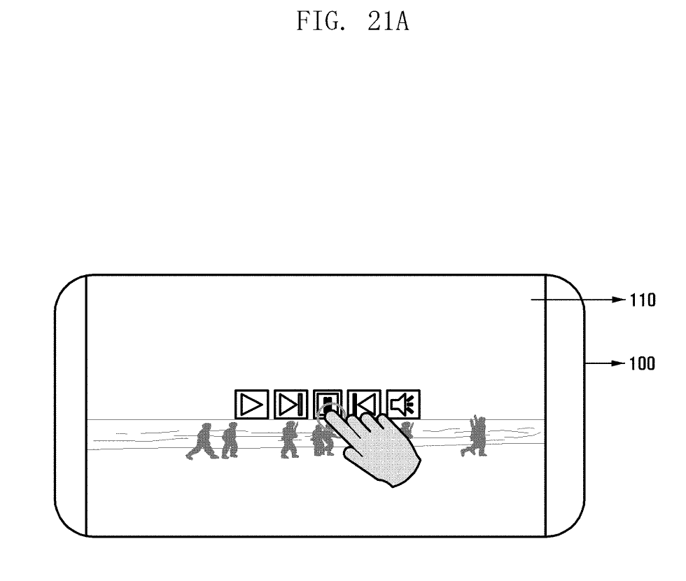

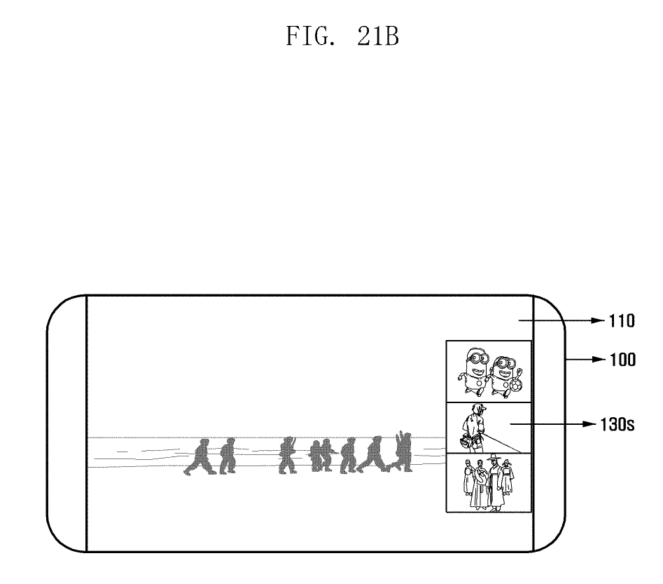

In an embodiment, the event indicates a temporary stop on a portion of the content while the user is scrolling the content (as shown in FIG. 21A). In an example, when the user is watching the cricket in a sports application and an advertisement is shown in the sports application during the cricket match, and the electronic device 100 detects the temporary stop based on the user gaze during the advertisement then the electronic device 100 dynamically displays a relevant advertisement related to the cricket.

After detecting the event, the electronic device 100 dynamically determines a context of the content based on a scrolling pattern of the content.

In an embodiment, the scrolling pattern of the content of the application is determined based on an interaction pattern of the user with a portion of the content, while scrolling the content. In an embodiment, the interaction pattern is dynamically determined based on a speed of scrolling the content, a time spent by the user on the portion of the content while scrolling the content, and a filter used while scrolling the content.

In an example, if the speed of the scrolling is slow or halt then, the electronic device 100 determines that the user is interested on the portion of content displayed on the display 110. In another example, if the speed of the scrolling is fast then, the electronic device 100 determines that the user is not interested to view the content on the display 110 and may search for other content.

In an example, if the time spent by the user is more on the portion of the content displayed on the display 110 then, the electronic device 100 determines that the user is interested on the content.

In an example, as shown in the FIG. 1B, if the user is using the filter (such as based on location) in the gallery application then, the electronic device 100 determines that the user is searching for an image in the filtered location.

In another embodiment, the scrolling pattern of the content of the application is determined based on the interaction pattern of the content of the at least one application. The interaction pattern of the content of the application can be a usage history in the application.

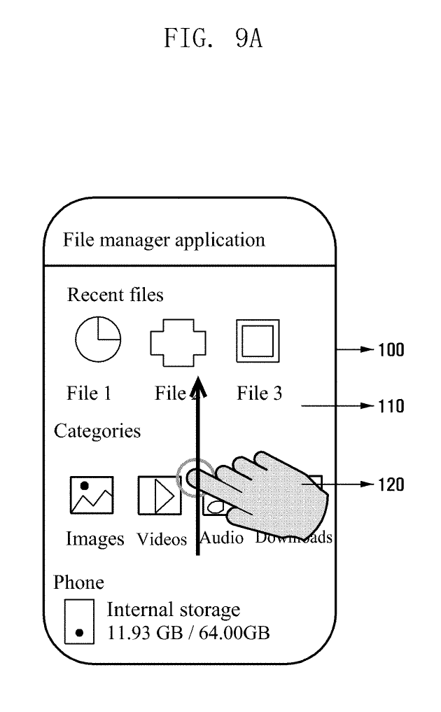

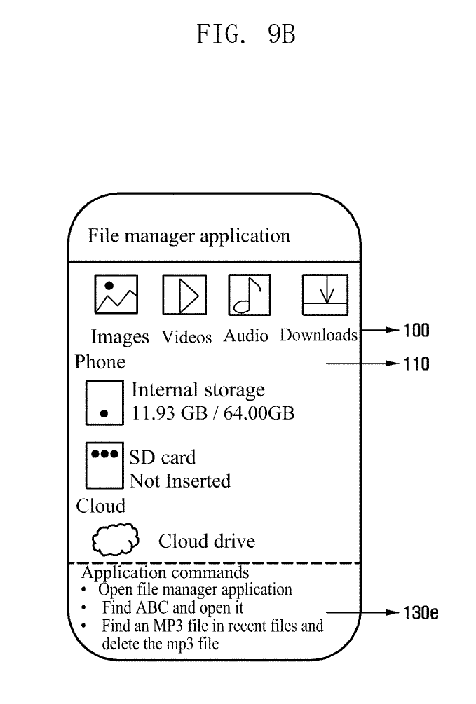

In an embodiment, the usage history includes frequent actions performed in the application. For example, if the user frequently performs viewing/editing the images in the gallery application then, the electronic device 100 determines that the frequent action for the gallery application as viewing/editing the images (as shown in FIG. 9A and FIG. 9B).

In an embodiment, the usage history includes a favorite content within the application. For example, if the user frequently views a particular image from a plurality of images in the gallery application then, the electronic device 100 determines that the favorite content for the gallery application as viewing the particular image.

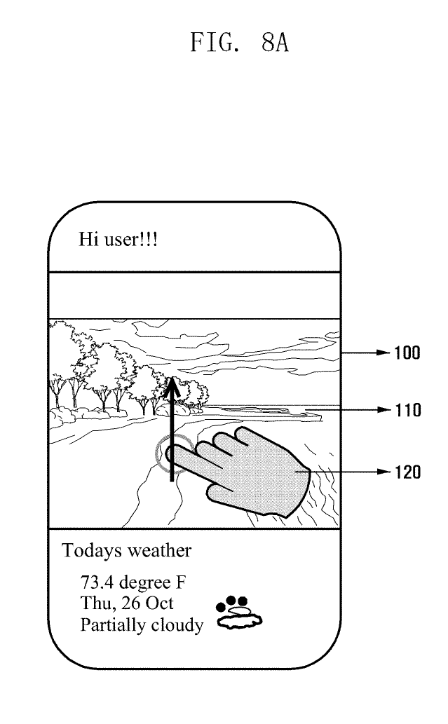

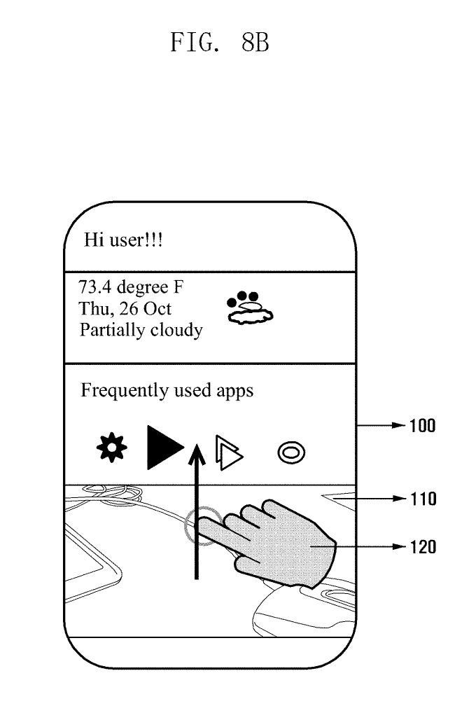

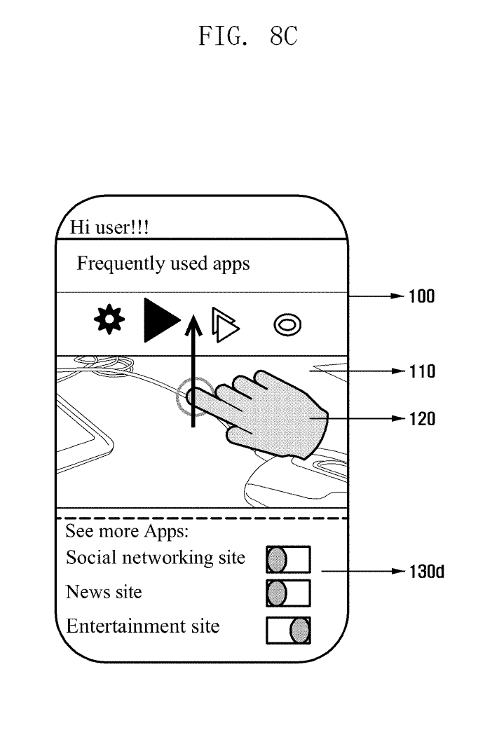

In an embodiment, the usage history includes a sequence of usage of multiple applications. For example, normally if the user browses the web browser application, a map application and the video application when searching for the content, then, electronic device 100 keeps track of those applications and provide recommendations of any missed application during searching for the content (as shown in FIGS. 8A-8C).

In another embodiment, the scrolling pattern of the content of the application is determined based on a switching pattern between one application and other application in the electronic device 100.

In an embodiment, the switching pattern is dynamically determined based on a type of action performed by the user for the portion of the content while scrolling the content, the other application running at the electronic device 100 and a user intent.

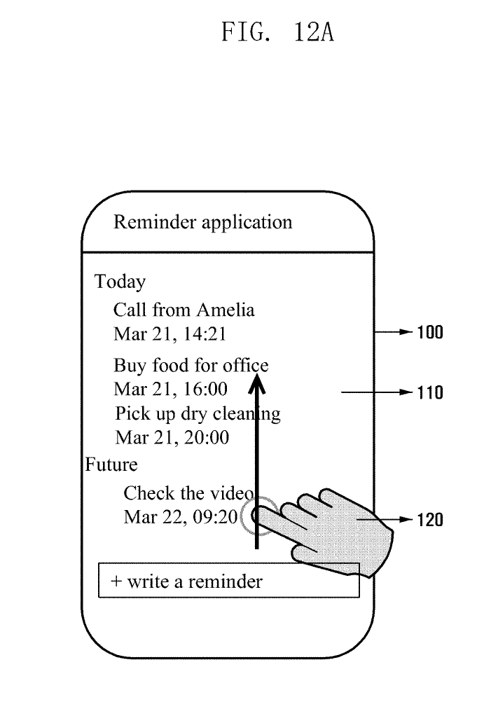

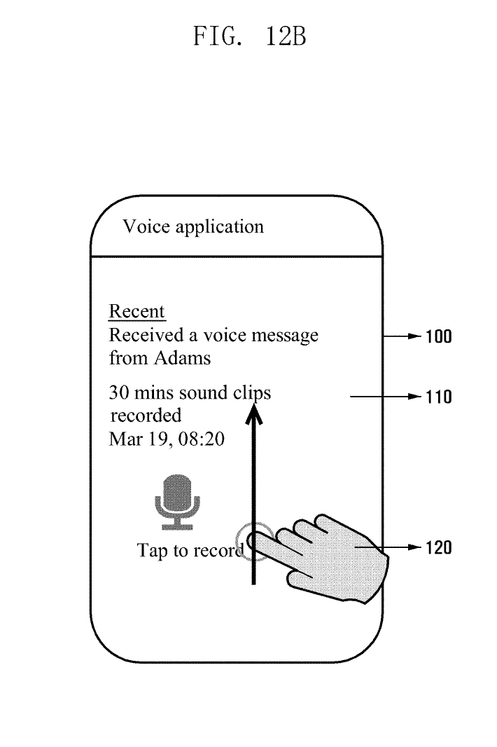

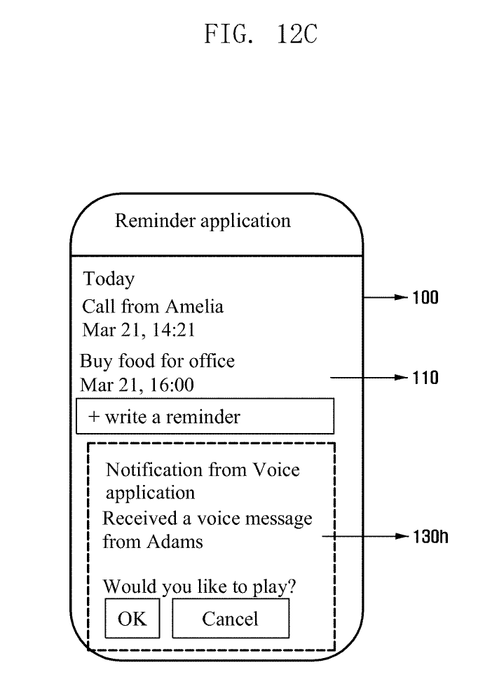

In an embodiment, the switching pattern includes a switching operation between applications within the electronic device 100. The electronic device 100 determines that the user is intended to engage in two applications simultaneously. In response to the determination, the electronic device 100 can be configured to display the update of the other application (e.g., a second application) on a currently displayed application (e.g., a first application). For example, if the user is switching between the web browser application and the chat application, where the web browser application is a primary focus application then, the electronic device 100 can display the update of the chat application in the web browser application (as shown in FIGS. 12A-12C).

In an embodiment, the switching pattern includes a switching ON and OFF of the electronic device 100. Based on the switching pattern, the electronic device 100 determines that the user may be engaged in other activities (e.g. cooking) during switch OFF of the electronic device 100 and when the electronic device 100 is switched ON, the user is viewing the content in the application (e.g., video application). In response to the determination, the electronic device 100 displays any missed updates of the application, during the switch OFF time of the electronic device 100. For example, consider the user is viewing a video in the video application of the electronic device 100, and switch OFF the electronic device 100 for a time (e.g., 10 minutes) in order to perform the other activities (i.e., cooking). Once, the electronic device 100 is switched ON, the electronic device 100 can display any missed videos in the video application in order to ensure that the videos are not missed during the switch OFF time of the electronic device 100.

In an embodiment, the scrolling pattern of the content of the application is determined based on the context of the application.

In an embodiment, the context of the application is determined by determining a domain of the application, features supported by the application, linked apps with the application, the content supported by the application, the user intent associated with the application and a user interaction pattern with the application.

In an embodiment, the context of the application includes domain of the application. For example, if the user is viewing the gallery application then, the current application domain can be an imaging domain.

In an embodiment, the context of the application includes an application page.

In an embodiment, the context of the application includes an application architecture. For example, if the user is viewing the gallery application then, the application architecture can be a functional design of the gallery application.

In an embodiment, the context of the application includes an application content and associated functions. For example, the application content and the associated functions can be sharing photos, editing photos, or the like.

In an embodiment, the electronic device 100 is configured to determine the user interaction with the application. In an embodiment, the user interaction with the application can be a continuous scroll/swipe in one direction, a to and fro scrolling and a slow-down/a halt to consume scrolling.

In an embodiment, the electronic device 100 determines that the user is intended to browse the content in response to the continuous scroll/swipe in one direction (e.g., an upward direction, a downward direction, a right side direction or a left side direction). Further, the electronic device 100 can display various contents on the display 110 to keep the user engaged in the application.

For example as shown in the FIG. 1A, if the user performs the operation (i.e. the continuous scroll/swipe) on the camera album of the gallery application, where the gallery application is currently viewed on the electronic device 100 then, the electronic device 100 may display more images from other albums in order to keep the user engaged.

In an embodiment, the electronic device 100 determines that the user is intended to search for a known content in response to the ‘to and fro scrolling’. Further, the electronic device 100 can display the content which is similar to the context in order to support search-ability.

For example, if the user performs the operation (i.e. to and fro scroll) on the camera album of the gallery application then, the electronic device 100 can provide more images of people, a theme related to the context(i.e., camera album) which provides ease of search-ability.

In an embodiment, the electronic device 100 determines that the user is interested on a selective content in response to the slow-down/the halt to consume scrolling. Further, the electronic device 100 can display functions related to the context along with the supported search-ability.

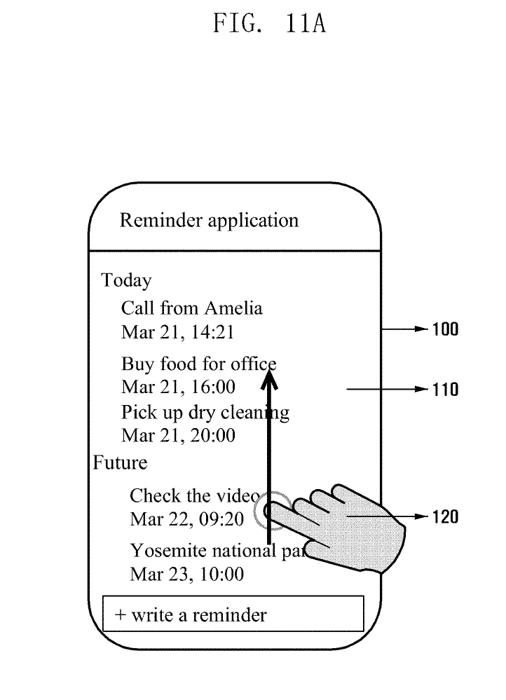

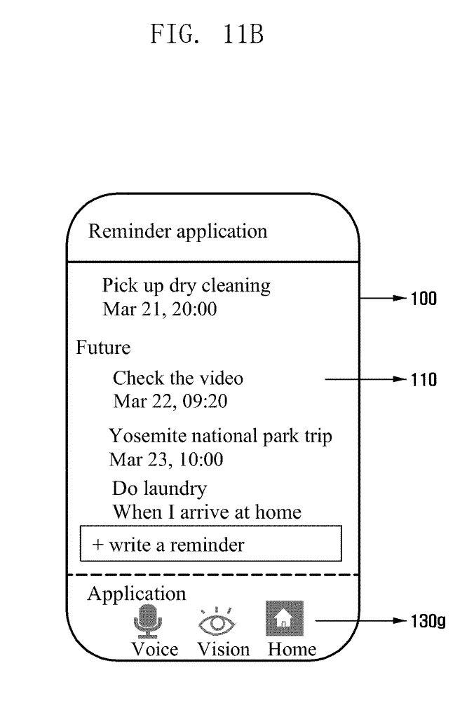

For example, if the user performs the operation (i.e., the slow-down/the halt to consume scroll) on the article currently browsed on the web browser application executed in the electronic device 100. The electronic device 100 can suggest other articles which are similar to the content in the article (currently displayed) or provide suggestion (such as search with other application (e.g., vision intelligence based virtual assistant)) (as shown in FIG. 11B).

In response to the determination of the context of the content based on the scrolling pattern of the content, the electronic device 100 can generate the visual cue based on the context of the content.

Further, the electronic device 100 can be configured to detect the direction of scrolling of the content. The visual cue is displayed in the direction of the scrolling of the content in the application of the electronic device 100. For example, as shown in the FIG. 1B, the electronic device 100 displays the visual cue 130a in the direction of scrolling of the content (i.e., at the end of the gallery application). The visual cue 130a can include the filter for viewing the images or provide a message saying that ‘view more images on cloud’.

In an embodiment, the visual cue can be an end effect displaying at least one of the message, a control information, a filter, an action command related to the context of the content displayed in the electronic device 100.

Consider an example scenario, in which the user performs the gesture on the content of the web browser application executed in the electronic device 100. The electronic device 100 detects the gesture 120 and determines that the user is about to reach the end of the web browser application currently displayed on the display 110. Further, the electronic device 100 determines the context associated with the content in the web browser application and displays the visual cue (e.g., recommendation includes interested content) based on the context.

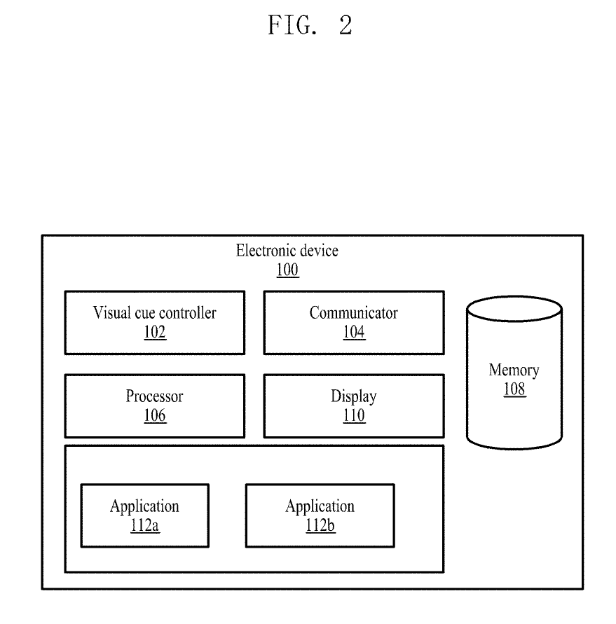

FIG. 2 illustrates a block diagram of various hardware components of the electronic device 100, according to an embodiment as disclosed herein. In an embodiment, the electronic device 100 includes a visual cue controller 102, a communicator 104, a processor 106, a memory 108, the display 110 and a set of applications 112a and 112b, (hereafter, label of the application is 112). The set of applications 112 is executed in the electronic device 100.

In an embodiment, the visual cue controller 102 can be configured to detect the event while the user is scrolling the content in the application 112. In response to the detection of the event, the visual cue controller 102 can be configured to dynamically determine the context of the content based the scrolling pattern of the content.

In an embodiment, the visual cue controller 102 can be configured to determine the scrolling pattern of the content based on the interaction pattern of the user with the portion of the content, while scrolling the content. The visual cue controller 102 can be configured to determine the interaction pattern based on the speed of scrolling the content, the time spent by the user on the portion of the content while scrolling the content, and the filter used while scrolling the content.

In an embodiment, the visual cue controller 102 can be configured to determine the scrolling pattern of the content based on the interaction pattern of the content of the at least one application 112.

In an embodiment, the visual cue controller 102 can be configured to determine the scrolling pattern of the content based on the switching pattern between one application 112a and other application 112b in the electronic device 100.

In an embodiment, the visual cue controller 102 can be configured to determine the scrolling pattern of the content based on the context of the at least one application 112. Further, the visual cue controller 102 can be configured to determine the context of the application 112 based on the domain of the application 112, the features supported by the application 112, the linked apps with the application 112, the content supported by the application 112, the user intent associated with the application 112 and the user interaction pattern with the application 112.

Based on the determination of the context of the content, the visual cue controller 102 can be configured to generate the visual cue. Further, the visual cue controller 102 can be configured to detect the direction of scrolling of the content. Furthermore, the visual cue controller 102 can be configured to display the visual cue in the direction of scrolling of the content on the display 110.

The communicator 104 is configured to communicate internally between hardware components in the electronic device 100. The processor 106 is coupled with the memory 108 for processing various instructions stored in the memory 108 to generate the visual cue on the display 110.

The memory 108 can be configured to store the usage history, the scrolling pattern of the content, context of the application 112, and the interaction pattern of the content. The memory 108 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 108 may, in some examples, be considered a non-transitory storage medium. The term “non-transitory” may indicate that the storage medium is not embodied in a carrier wave or a propagated signal. However, the term “non-transitory” should not be interpreted that the memory 108 is non-movable. In some examples, the memory 108 can be configured to store larger amounts of information than the memory. In certain examples, a non-transitory storage medium may store data that can, over time, change (e.g., in Random Access Memory (RAM) or cache).

The display 110 can be configured to display the content of the application 112 and the generated visual cue on the electronic device 100. Further, the display 110 can be a touch screen display for providing various contents (e.g., visual cue, visual indicator, visual icon etc.) on the electronic device 100. The display 110 can be a multi window display, a curved display, an edge based display, or the like. The display 110 can be, for example, but not limited to a Liquid Crystal Display (LCD), an Active Matrix Organic Light Emitting Diode (AM-OLED) display, a Light Emitting Diode (LED) display, or the like.

Although the FIG. 2 shows various hardware components of the electronic device 100 but it is to be understood that other embodiments are not limited thereon. In other embodiments, the electronic device 100 may include less or more number of components. Further, the labels or names of the components are used only for illustrative purpose and does not limit the scope of this disclosure. One or more components can be combined together to perform same or similar function of displaying the visual cue based on the context of the content.

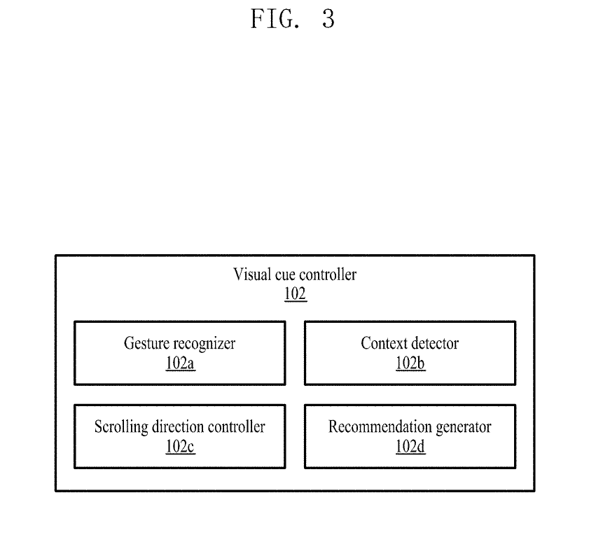

FIG. 3 illustrates a block diagram of various hardware components of the visual cue controller 102, according to an embodiment as disclosed herein. In an embodiment, the visual cue controller 102 includes a gesture recognizer 102a, a context detector 102b, a scrolling direction controller 102c and a recommendation generator 102d.

The user performs the gesture 120 on the content being displayed on the display 110. The user can use hand or can use a stylus as a pointing device to perform the gesture 120 on the display 110 in order to operate the electronic device 100.

The gesture recognizer 102a is configured to recognize the gesture 120 associated with the content currently displayed on the display 110 of the electronic device 100. Further, the gesture recognizer 102a may be further configured to detect the event, while the user scrolling the content.

In response to the detection of the event, the context detector 102b can be configured to determine the context of the content based the scrolling pattern of the content.

In an embodiment, the context detector 102b can be configured to determine the scrolling pattern of the content based on the interaction pattern of the user with the portion of the content, while scrolling the content. The context detector 102b can be configured to dynamically determine the interaction pattern based on the speed of scrolling the content, the time spent by the user on the portion of the content while scrolling the content, and the filter used while scrolling the content.

In an embodiment, the context detector 102b can be configured to determine the scrolling pattern of the content based on the interaction pattern of the content of the at least one application 112.

In an embodiment, the context detector 102b can be configured to determine the scrolling pattern of the content based on the switching pattern between one application 112a and other application 112b in the electronic device 100.

In an embodiment, the context detector 102b can be configured to dynamically determine the scrolling pattern of the content based on the context of the at least one application 112. The context detector 102b can be configured to determine the context of the application 112 based on the domain of the application 112, the features supported by the application 112, the linked apps with the application 112, the content supported by the application 112, the user intent associated with the application 112 and the user interaction pattern with the application 112.

Based on the determination of the context of the content, the recommendation generator 102d can be configured to generate the visual cue, where the visual cue comprises the recommendation of at least one key element contextually related to the content.

In an embodiment, the key element is operable by the user for at least one of dynamically filtering the content of the at least one application 112, dynamically associating at least one portion of the content of the at least one application 112a with other application 112b in the electronic device 100, and dynamically operating other application in the electronic device 100.

The scrolling direction controller 102c is configured to detect the direction of scrolling of the content of the at least one application 112. The recommendation generator 102d is configured to display the visual cue in the direction of the scrolling of the content.

Although the FIG. 3 shows various hardware components of the visual cue controller 102 but it is to be understood that other embodiments are not limited thereon. In other embodiments, the visual cue controller 102 may include less or more number of components. Further, the labels or names of the components are used only for illustrative purpose and does not limit the scope of this disclosure. One or more components can be combined together to perform same or similar function of displaying the visual cue based on the context of the content.

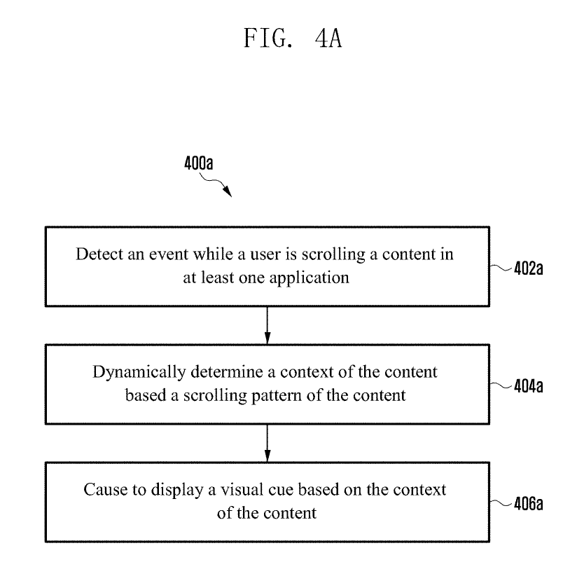

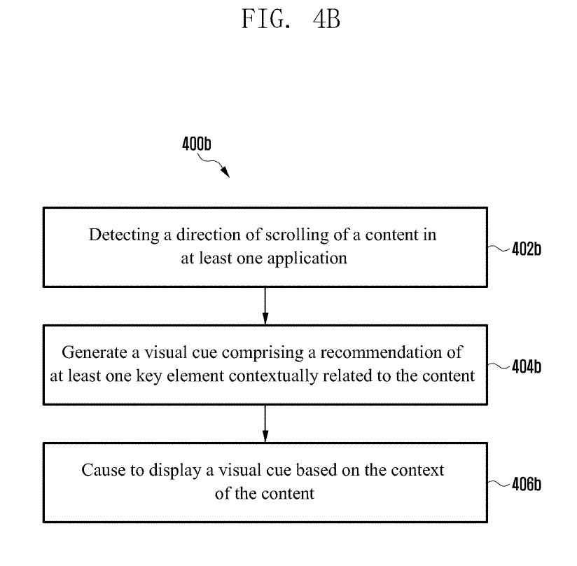

FIG. 4A illustrates a flow diagram 400a of various operations for displaying the visual cue by detecting the event while scrolling the content, according to an embodiment as disclosed herein.

At 402a, the method includes detecting the event while the user is scrolling the content in the at least one application 112. In an embodiment, the method allows the gesture recognizer 102a to detect the event while the user is scrolling the content in the at least one application 112.

At 404a, the method includes dynamically determining the context of the content based the scrolling pattern of the content. In an embodiment, the method allows the context detector 102b to dynamically determine the context of the content based the scrolling pattern of the content.

At 406a, the method includes causing to display the visual cue based on the context of the content. In an embodiment, the method allows the visual cue controller 102 to cause to display the visual cue based on the context of the content.

The various actions, acts, blocks, steps, or the like in the flow diagram 400a may be performed in the order presented, in a different order or simultaneously. Further, in some embodiments, some of the actions, acts, blocks, steps, or the like may be omitted, added, modified, skipped, or the like without departing from the scope of this disclosure.

FIG. 4B illustrates a flow diagram 400b of various operations for displaying the visual cue by detecting the direction of scrolling of the content, according to an embodiment as disclosed herein.

At 402b, the method includes detecting the direction of scrolling of the content in the at least one application 112. In an embodiment, the method allows the scrolling direction controller 102c to detect the direction of scrolling of the content in the at least one application 112.

At 404b, the method includes generating the visual cue includes the recommendation of the at least one key element contextually related to the content. In an embodiment, the method allows the recommendation generator 102d to generate the visual cue includes the recommendation of the at least one key element contextually related to the content.

At 406b, the method includes causing to display the visual cue based on the context of the content. In an embodiment, the method allows the visual cue controller 102 to cause to display the visual cue based on the context of the content.

The various actions, acts, blocks, steps, or the like in the flow diagram 400b may be performed in the order presented, in a different order or simultaneously. Further, in some embodiments, some of the actions, acts, blocks, steps, or the like may be omitted, added, modified, skipped, or the like without departing from the scope of this disclosure.

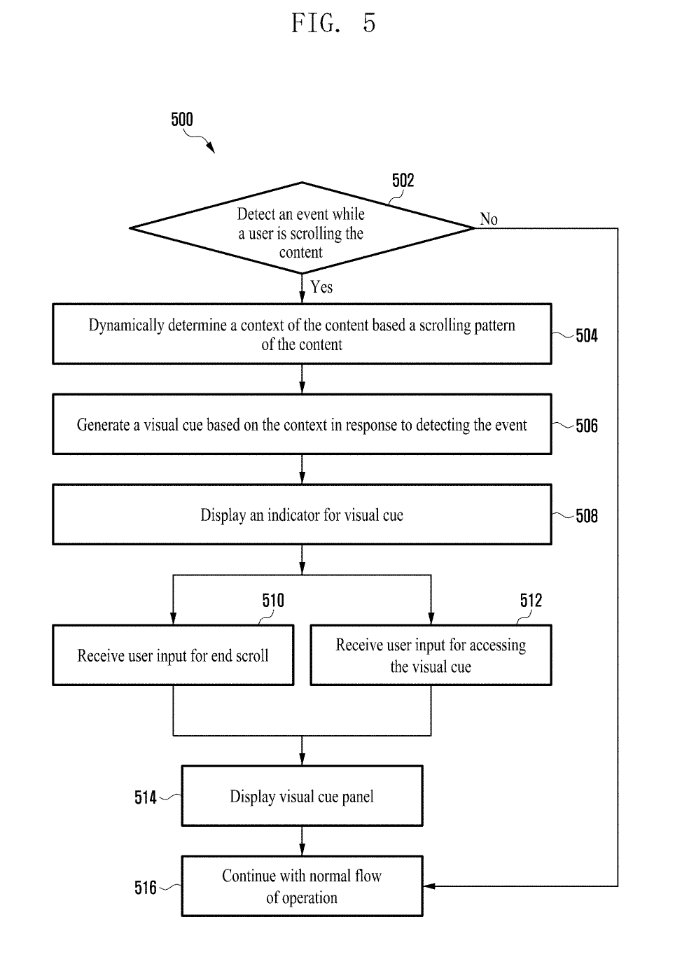

FIG. 5 illustrates an example flow diagram of various operations performed after displaying the visual cue on the display 110 of the electronic device 100, according to an embodiment as disclosed herein.

At 502, the method includes detecting the event while the user is scrolling the content in the application 112. In an embodiment, the method allows the gesture recognizer 102a to detect the event while the user is scrolling the content in the application 112.

At 504, the method includes dynamically determining the context of the content based the scrolling pattern of the content. In an embodiment, the method allows the context detector 102b to dynamically determine the context of the content based the scrolling pattern of the content.

At 506, the method includes generating the visual cue based on the context, in response to the detecting the event. In an embodiment, the method allows the recommendation generator 102d to generate the visual cue based on the context, in response to the detecting the event.

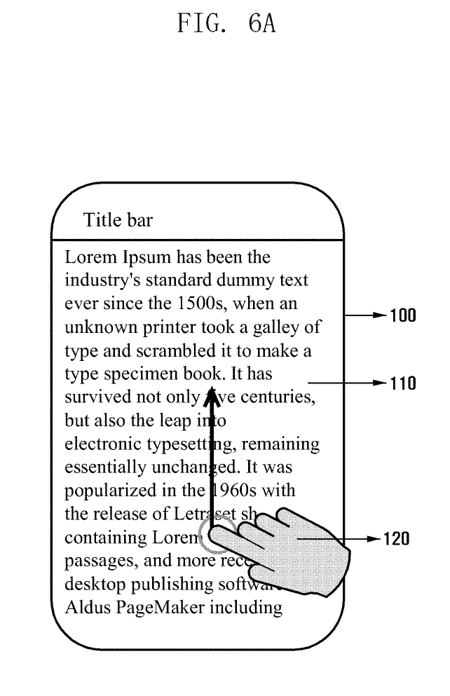

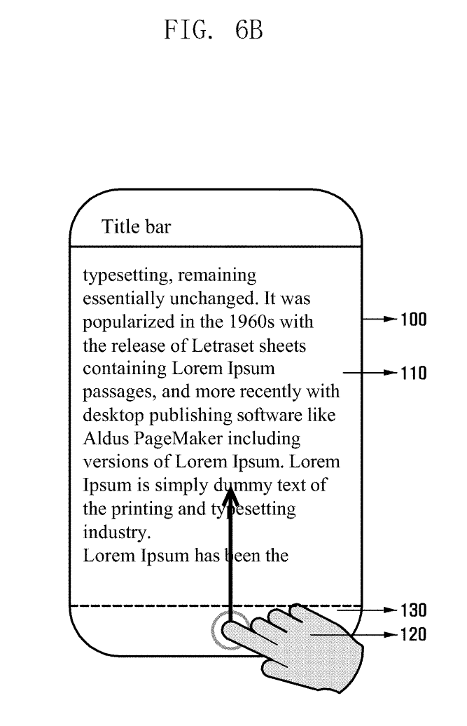

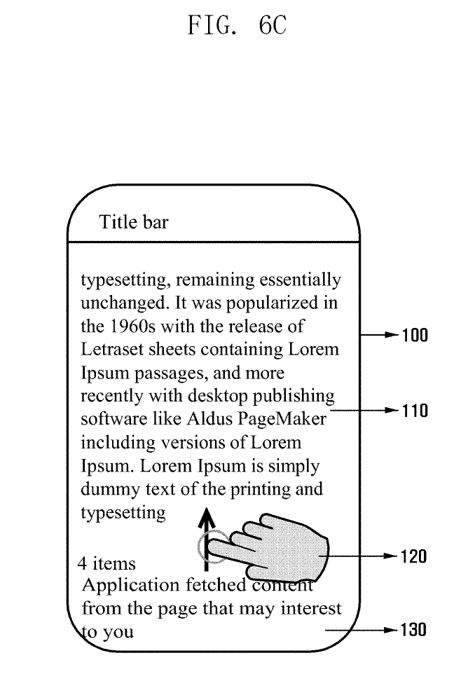

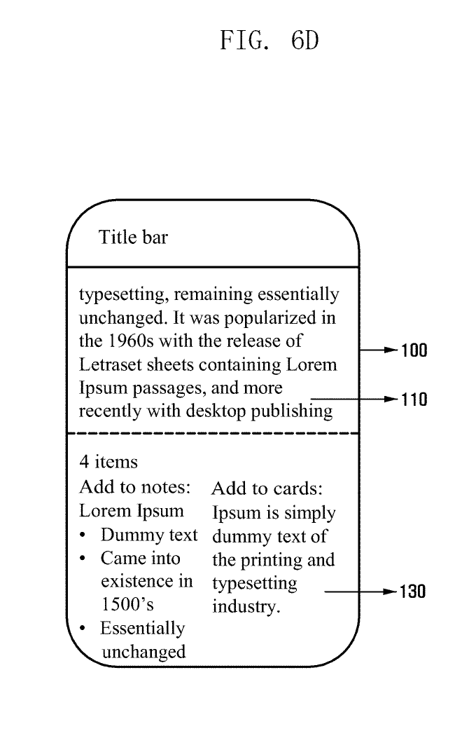

At 508, the method includes displaying an indicator for the visual cue. In an embodiment, the method allows the display 110 to display the indicator for the visual cue as shown in the FIGS. 6B-6D.

At 510, the method includes receiving the user input for an end scroll. In an embodiment, the method allows the gesture recognizer 102a to receive the user input for end scroll as shown in the FIG. 6C.

At 512, the method includes receiving user input for accessing the visual cue. In an embodiment, the method allows the gesture recognizer 102a to receive the user input for accessing the visual cue as shown in the FIG. 6C.

At 514, the method includes displaying the visual cue panel. In an embodiment, the method allows the display 110 to display the visual cue panel. The visual cue panel provides the interested content for the user as shown in the FIG. 6D.

At 516, the method includes continuing with a flow of operation. If the method does not detect the event then, at 516, the method includes continuing with the flow of operation.

The various actions, acts, blocks, steps, or the like in the flow diagram 500 may be performed in the order presented, in a different order or simultaneously. Further, in some embodiments, some of the actions, acts, blocks, steps, or the like may be omitted, added, modified, skipped, or the like without departing from the scope of this disclosure.

FIGS. 6A-6D illustrate examples in which the visual cue is displayed at the end portion of the web browser application executed in the electronic device 100, based on determining that the user reaches the end of the web browser application, according to an embodiment as disclosed herein.

Consider a scenario, in which the web browser application executed in the electronic device 100 provides the content (e.g., article). The user may need to find a particular content displayed on the web browser application. Further, the user performs the gesture 120 (e.g., scroll gesture) on the display 110 of the electronic device 100 as shown in the FIG. 6A. The electronic device 100 detects the gesture 120 performed on the content of the web browser application. Based on the detected gesture 120, the electronic device 100 provides the indicator 130 at the end of the web browser application currently displayed on the display 110 as shown in the FIG. 6B and FIG. 6C.

Based on the detected gesture 120, the electronic device 100 determines whether the user reaches the end of the content displayed on the web browser application. In response to the determination, the electronic device 100 determines the context associated with the content based on the scrolling pattern of the content. The context can be for example the web browser application, number of pages, application details, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130b and displays the visual cue 130b at the end of the content of the web browser application of the display 110 as shown in the FIG. 6D. For example, the visual cue 130b includes additional information (i.e., related to ‘Lorem Ipsum’) which is related to the content in the web browser application. This improves the user experience in finding the interested/particular content displayed on the web browser application of the electronic device 100.

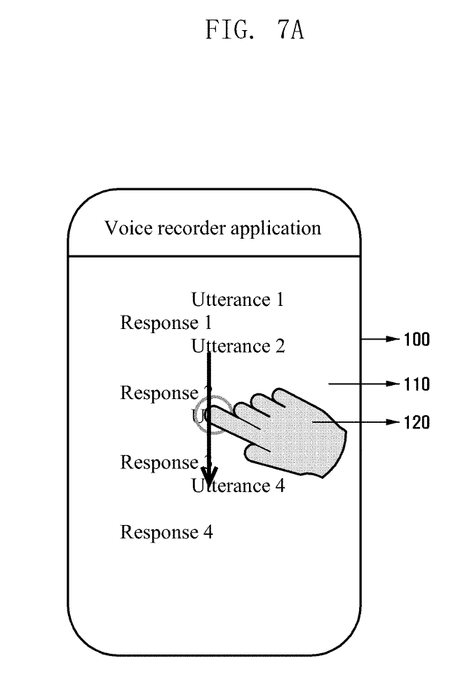

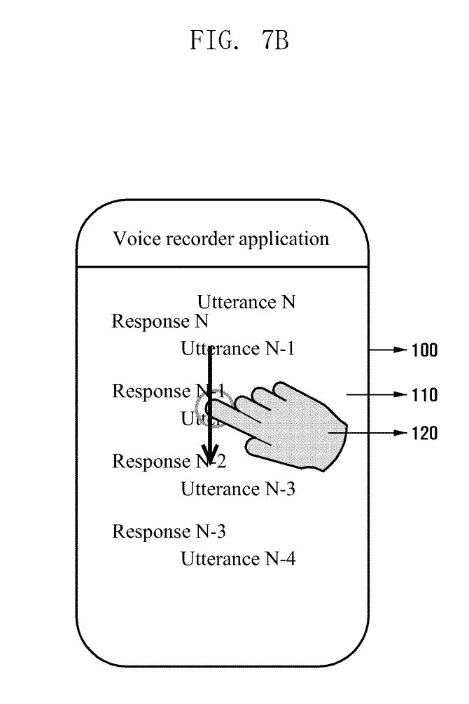

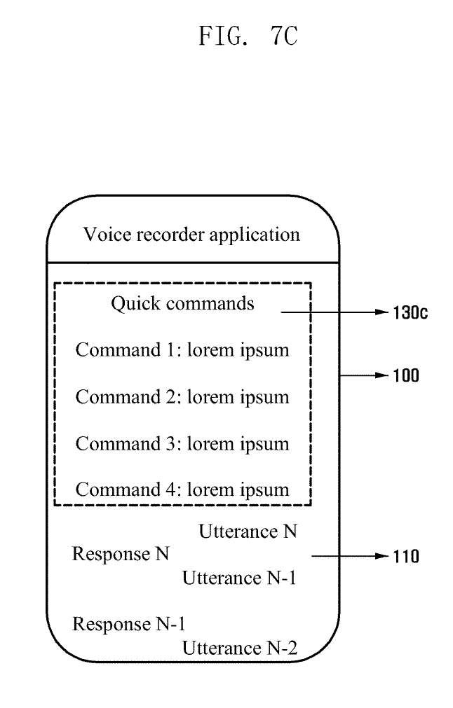

FIGS. 7A-7C illustrate examples in which the visual cue is displayed in the direction of scrolling of the content in the voice recorder application executed in the electronic device 100, based on determining that the user reaches the end of the content on the voice recorder application, according to an embodiment as disclosed herein.

Consider a scenario, in which the voice recorder application of the electronic device 100 displays a plurality of utterances which are recorded at the electronic device 100. The user may need to find a particular utterance recorded at the electronic device 100. Further, the user performs the gesture 120 (e.g., scroll gesture) on the display 110 of the electronic device 100 as shown in the FIG. 7A. The electronic device 100 detects the gesture 120 performed on the content of the voice recorder application.

Based on the detected gesture 120, the electronic device 100 determines the whether the user reaches the end of the utterances as shown in the FIG. 7B. In response to the determination, the electronic device 100 determines the context associated with the utterance based on the scrolling pattern of the content. The context can be for example but not limited to the voice recorder application, recently recorded utterances, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130c and displays the visual cue 130c in the direction of scrolling of the content as shown in the FIG. 7C. The visual cue 130c includes a quick commands for the particular utterance. This improves the user experience in finding the particular utterance available in the electronic device 100.

FIGS. 8A-8C illustrate examples in which the visual cue is displayed in the direction of scrolling of the content in the home application executed in the electronic device 100, based on detecting that the user is reaches the end of the home application, according to an embodiment as disclosed herein.

Consider a scenario, in which the home application is currently displayed on the display 110. The user may need to enable/disable the application (e.g., social networking application, news application, entertainment application or the like) in the electronic device 100. Further, the user performs the gesture 120 (e.g., scroll gesture) on the home application of the electronic device 100 as shown in the FIG. 8A and FIG. 8B. The electronic device 100 detects the gesture 120 performed on the home application.

Based on the detected gesture 120, the electronic device 100 determines the event (e.g., whether the user is reaches the end of the home application). In response to the determination, the electronic device 100 determines the context associated with the home application based on the scrolling pattern of the content. The context can be for example the home screen, a virtual assistant based home application, number of pages in the home screen, pinned widgets, etc. The scrolling pattern can be for example but not limited to the to-and-fro scrolling, the continuous scrolling in one direction, the slow down or halt scrolling, or the like.

Further, the electronic device 100 generates the visual cue 130d (e.g., recommendation) based on the context associated with the content and displays the visual cue 130d in the direction of scrolling of the content (i.e., at the end of the application) as shown in the FIG. 8C. The visual cue 130d provides the recommendations which allows the user to enable/disable the application on the home application. This improves the user experience in enabling/installing the uninstalled application in the electronic device 100.

FIG. 9A and FIG. 9B illustrate examples in which the visual cue is displayed at the end of the file manager application associated with the electronic device 100, based on determining the interaction pattern (i.e., usage history) of the content on the file manager application, according to an embodiment as disclosed herein.

Consider a scenario, in which the file manager application is currently displayed on the display 110. Further, the user performs the gesture 120 (e.g., scroll gesture) on the file manager application currently displayed on the display 110 as shown in the FIG. 9A. The electronic device 100 detects the gesture 120 performed on the content of the file manager application.

Based on the detected gesture 120, the electronic device 100 determines that the user reaches the end of the content presented in the file manager application. In response to the determination, the electronic device 100 determines the context associated with the content based on the scrolling pattern of the content. The scrolling pattern can be for example but not limited to the to-and-fro scrolling, the continuous scrolling in one direction, the slow down or halt scrolling, or the like. Further, the electronic device 100 detects the direction of scrolling of the content.

Based on the context associated with the content and the direction of scrolling of the content, the electronic device 100 generates the visual cue 130e and displays the visual cue 130e in the direction of scrolling of the content (i.e., at the end of the file manager application) as shown in the FIG. 9B. For example, the visual cue 130e includes the frequent actions performed by the user on the file manager application. The visual cue 130e include: Open file manager application, Find ABC and open it, Find an MP3 file in recent files and delete the MP3 file. This improves the user experience in performing the operation on the file manager application of the electronic device 100.

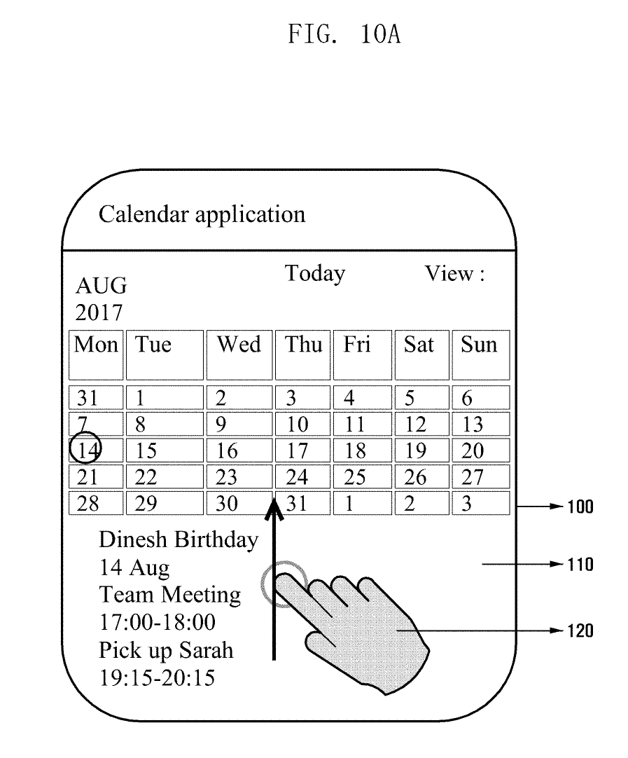

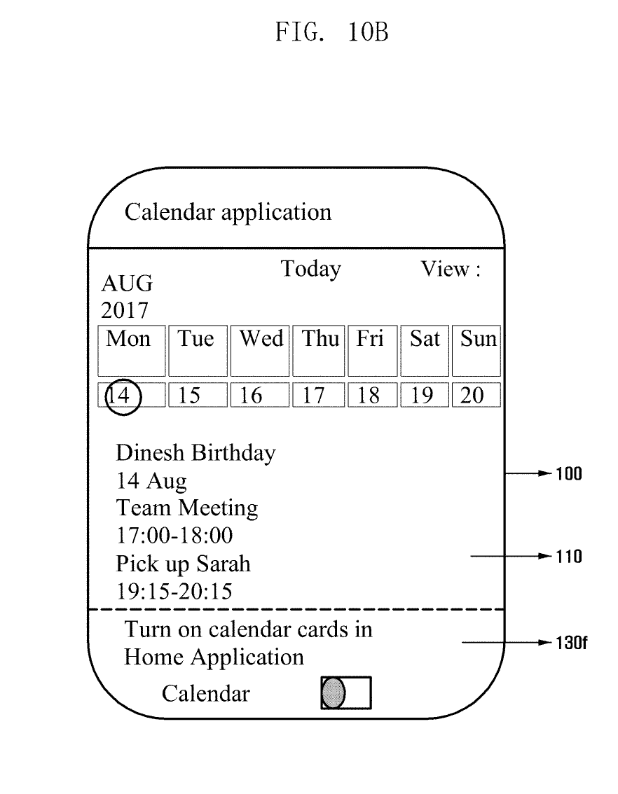

FIG. 10A and FIG. 10B illustrate examples in which the visual cue is displayed at the end portion of the content in the calendar application executed in the electronic device 100, based on detecting that the user reaches the end of the content on the calendar application, according to an embodiment as disclosed herein.

Consider a scenario, in which the calendar application is currently displayed on the display 110, and the calendar card is disabled in a virtual assistant based home application, as a pre-condition. The user may need to enable a calendar card in the virtual assistant based home application. Further, the user performs the gesture 120 (e.g., scroll gesture) on the calendar application as shown in the FIG. 10A. Further, the electronic device 100 detects the gesture 120 performed on the content of the calendar application.

Based on the detected gesture 120, the electronic device 100 determines that the user reaches the end of the content displayed on the calendar application. In response to the determination, the electronic device 100 determines the context the associated with the content based on the scrolling pattern of the content. The context can be for example but not limited to the usage history of the calendar application, saved events in the calendar application, and tasks (e.g., birthday notification alert, team meeting reminder, or the like) associated with the calendar application. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and the direction of scrolling of the content, the electronic device 100 generates the visual cue 130f and displays the visual cue 130f in the direction of scrolling of the content (e.g., at the end of the calendar application) as shown in the FIG. 10B. For example, the visual cue 130f includes enabling the calendar card in the home application (such as virtual assistant based home application) as shown in the FIG. 10B. This improves the user experience in enabling the calendar card in the home application of the electronic device 100.

FIG. 11A and FIG. 11B illustrate examples in which the visual cue is displayed at the end of the content in the reminder application in order to support linked application (e.g., voice assisted based virtual assistant, vision intelligence based virtual assistant, or the like) executed in the electronic device 100, based on determining the context of the reminder application, according to an embodiment as disclosed herein.

Consider a scenario, in which the reminder application (such as virtual assistant based reminder application) is currently displayed on the display 110. The user may need to view other application linked with the reminder application. For example, if the user is viewing the virtual assistant based reminder application and is interested to view other virtual assistant application (e.g., voice assisted based virtual assistant, vision intelligence based virtual assistant, or the like). Further, the user performs the gesture 120 (e.g., scroll gesture) on the reminder application displayed on the display 110 as shown in the FIG. 11A. Further, the electronic device 100 detects the gesture 120 performed on the content of the reminder application.

Based on the detected gesture 120, the electronic device 100 determines that the user reaches the end of the content displayed on the reminder application. In response to the determination, the electronic device 100 determines the context the associated with the content based on the scrolling pattern of the content. The context can be for example but not limited to the content in the reminder application, the linked application details, etc. The scrolling pattern can be for example but not limited to the to-and-fro scrolling, the continuous scrolling in one direction, the slow down or halt scrolling, or the like. The electronic device 100 can be configured to detect the direction of scrolling of the content on the reminder application.

Based on the context associated with the content and direction of scrolling of the content, the electronic device 100 generates the visual cue 130g and displays the visual cue 130g in the direction of scrolling of the content (i.e., at the end of the reminder application) as shown in the FIG. 11B. For example, the visual cue 130g includes other virtual assistant based applications (e.g., vision intelligence based virtual assistant, vision intelligence based virtual assistant or the like) which are linked with the virtual assistant based reminder application. This improves the user experience in viewing the other applications linked with the reminder application.

FIGS. 12A-12C illustrate examples in which the visual cue is displayed at the end of the content in the reminder application executed in the electronic device 100, based on determining the switching pattern of the content on the reminder application, according to an embodiment as disclosed herein.

Consider a scenario, in which the reminder application (such as virtual assistant based reminder application) is currently displayed on the display 110 of the electronic device 100. The user is navigated to another application (e.g., voice recorder application) as shown in the FIG. 12B. Further, the user performs switching back to the reminder application and performs the gesture 120 (e.g., scroll gesture) on the reminder application currently displayed on the display 110 as shown in the FIG. 12A. The electronic device 100 detects the gesture 120 performed on the content of the reminder application.

Based on the detected gesture 120, the electronic device 100 determines that the user reaches the end of the content in the reminder application. Further, the electronic device 100 determines that the reminder application is the primary focus application and the user is switching to another application (e.g., the voice recorder application). In response to the determination, the electronic device 100 determines the context the associated with the content based on the scrolling pattern of the content. The context of can be for example but not limited to the content in the reminder application, the content in the voice recorder application the application details, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130h and displays the visual cue 130h in the direction of scrolling of the content (i.e., at the end of the reminder application) as shown in the FIG. 12C. For example, the visual cue 130h includes displaying a notification from the voice recorder application in the reminder application. The notification includes the message saying that “receiving a voice message from Adam, would you like to play” as shown in the FIG. 12C. This improves the user experience in viewing the updates of other application on the currently displayed application.

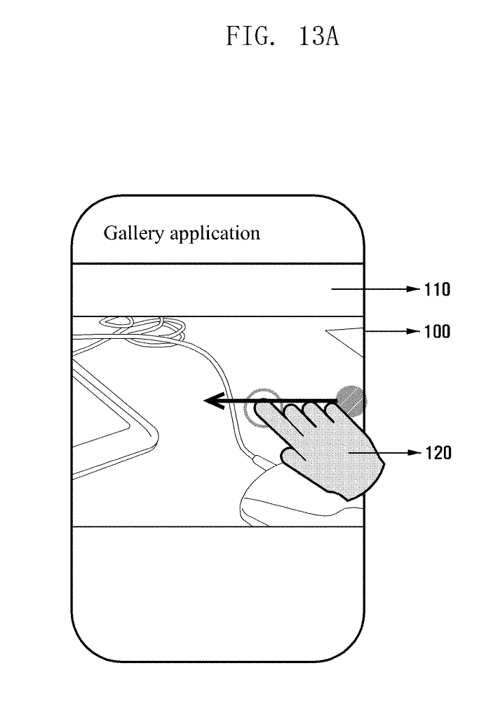

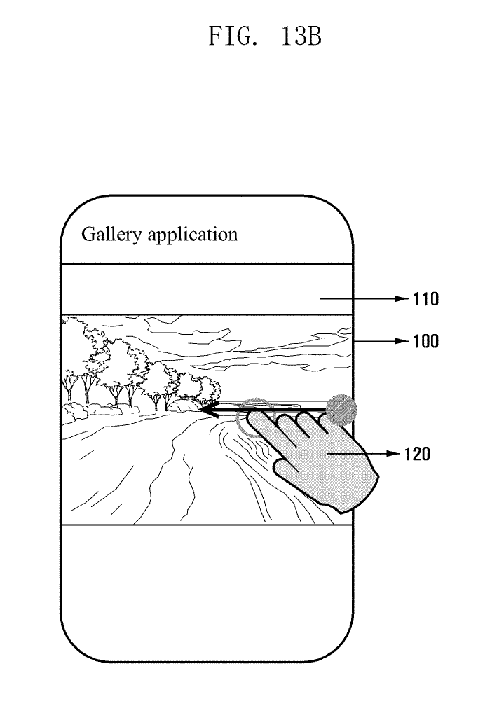

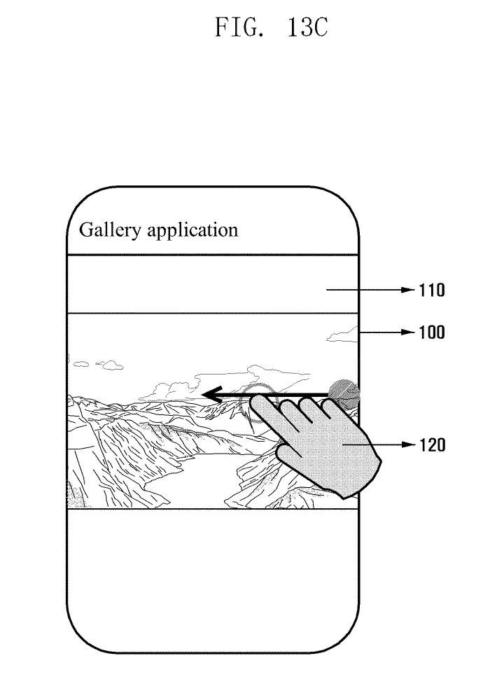

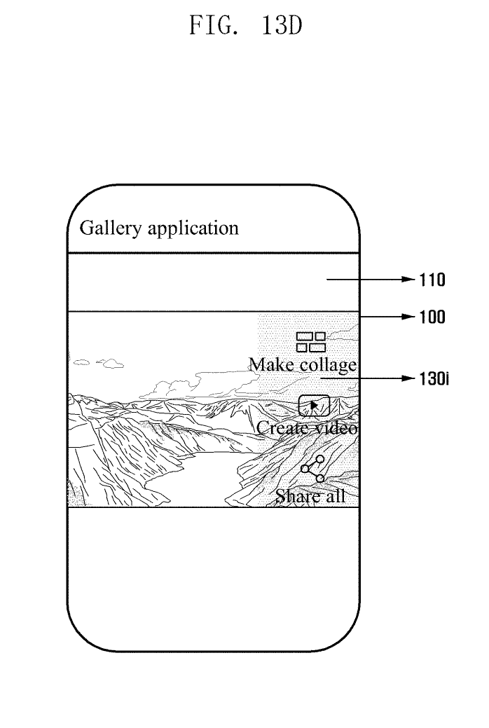

FIGS. 13A-13D illustrate examples in which the visual cue is displayed in the direction of scrolling of the content in the gallery application executed in the electronic device 100, based on detecting that the user reaches the end of the content on the gallery application, according to an embodiment as disclosed herein.

Consider a scenario, in which the gallery application is currently displayed on the display 110 of the electronic device 100. The user may need to perform actions (e.g., collage the images, share the images to others, etc.) in the gallery application. Further, the user performs the gesture 120 (e.g., scroll gesture) on the gallery application currently opened on the display 110. In order to view the images in the gallery application as shown in the FIGS. 13A-13C, the user performs the gesture 120 (e.g., swipe gesture in a right direction) on the display 110. The electronic device 100 detects the gesture 120 performed on the content of the gallery application.

Based on the detected gesture 120, the electronic device 100 determines that the user reaches the end of the images in the gallery application. In response to the determination, the electronic device 100 determines the context the associated with the image on the gallery application based on the scrolling pattern of the content. The context can be for example but not limited to the gallery application, a current page (such as albums, pictures and stories), views (such as a thumbnail view, a detail view, a list view), type of media (such as picture, panorama, selfie, video) and an associated details/metadata of albums, pictures. The scrolling pattern can be for example but not limited to the to-and-fro scrolling, the continuous scrolling in one direction, the slow down or halt scrolling, or the like.

Based on the context associated with the content and direction of scrolling of the content, the electronic device 100 generates the visual cue 130i (e.g., actions) and displays the visual cue 130i in the direction of scrolling of the content (i.e., the right side of the gallery application) of the display 110 as shown in the FIG. 13D. For example, the visual cue 130i includes create collage, create video, share all, etc. This improves the user experience in performing various actions in the gallery application.

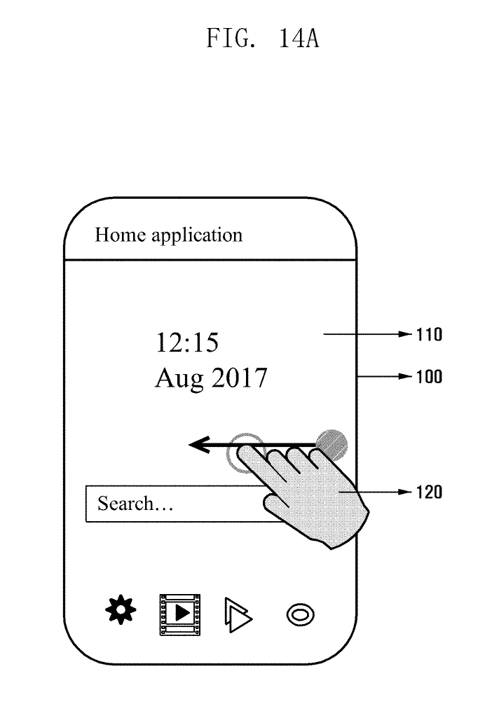

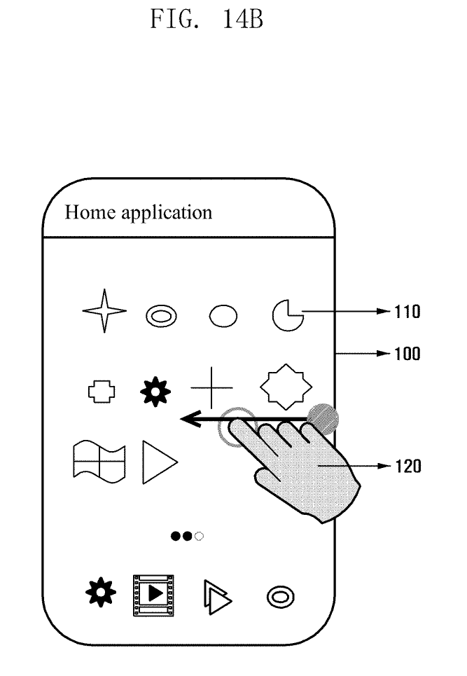

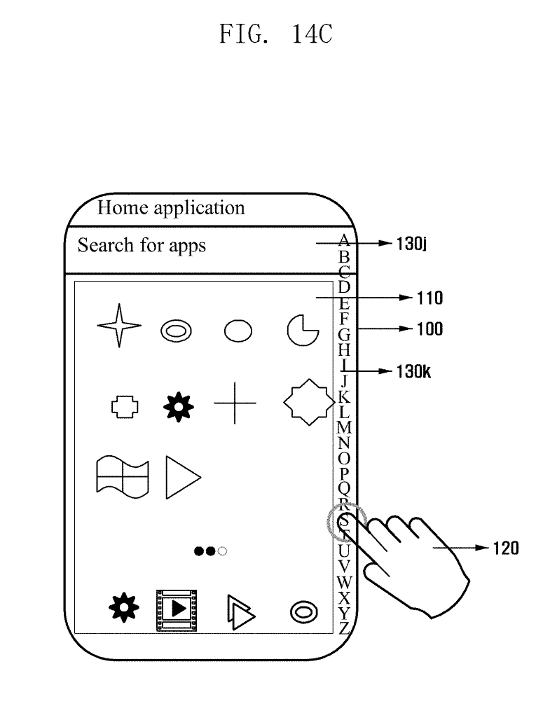

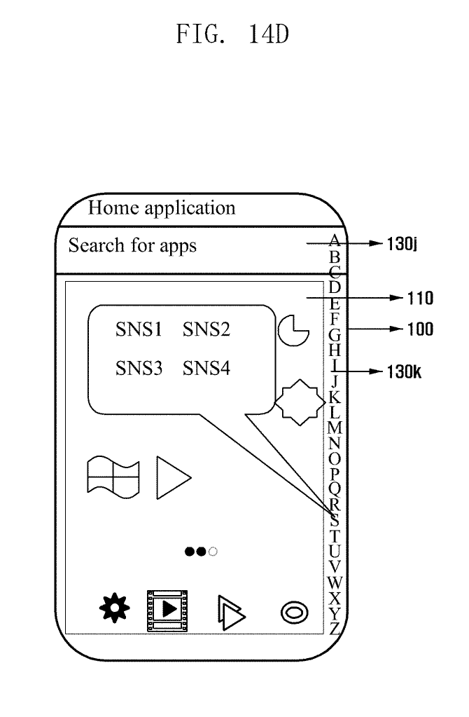

FIGS. 14A-14D illustrate examples in which the visual cue is displayed in the direction of scrolling of the content in the home application executed in the electronic device 100, based on detecting that the user reaches the end of the content on the home application, according to an embodiment as disclosed herein.

Consider a scenario, in which the home application of the electronic device 100 displays a plurality of applications which are installed on the electronic device 100. Further, the user performs the gesture 120 (e.g., swipe gesture, scroll gesture or the like) on the home application as shown in the FIGS. 14A-14B. The electronic device 100 detects the gesture 120 performed on the plurality of the application in the home application.

Based on the detected gesture 120, the electronic device 100 determines that the user reaches the end of the home screen application or the user is about to reach the end of the home screen application. In response to the determination, the electronic device 100 determines the context associated with the plurality of application in the electronic device 100 based on the scrolling pattern of the content. The context can be for example but not limited to the plurality of application, home screen, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue (130j-130k) and displays the visual cue (130j-130k) in the direction of scrolling of the content (e.g., at the right side of the display 110) as shown in the FIG. 14C. The visual cue includes a search box 130h and an index scroll 130i as shown in the FIG. 14C. For e.g., when the user scrolls through the index scroll 130i and hovers over the letter ‘s’, the electronic device 100 provides a list of applications starting with the letter ‘s’ as shown in the FIG. 14D. This improves the user experience in searching for the particular application using the search box 130j or through the index scroll 130k.

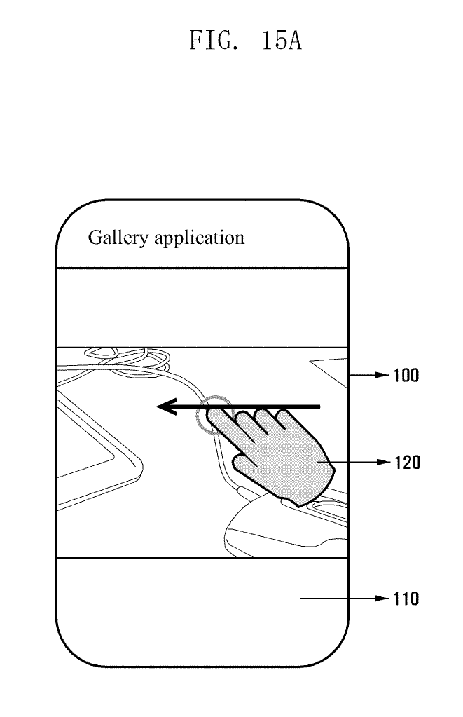

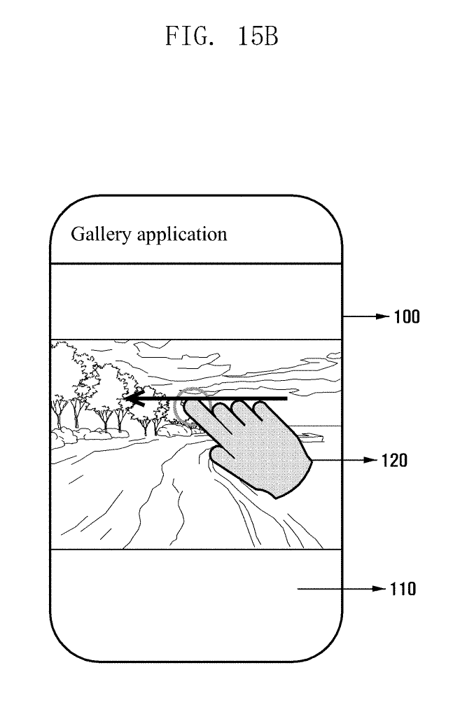

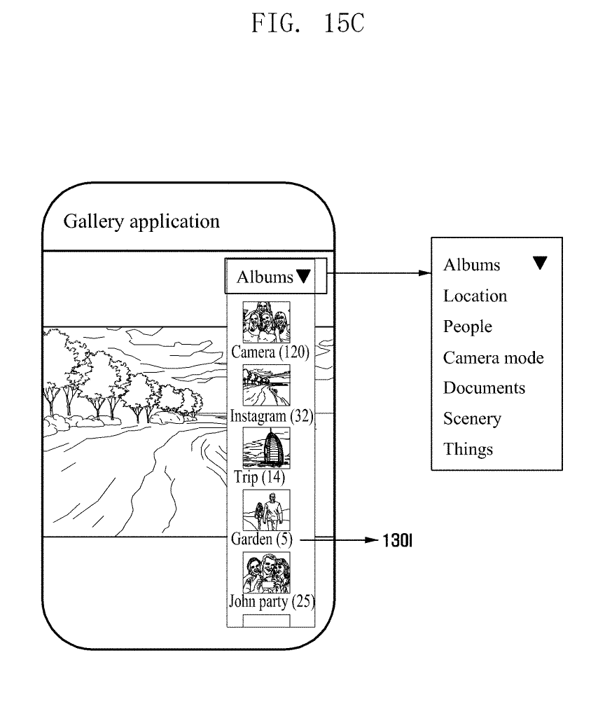

FIGS. 15A-15C illustrate examples in which the visual cue is displayed in the direction of scrolling of the content in the gallery application executed in the electronic device 100, based on detecting that the user reaches the end of the content on the gallery application, according to an embodiment as disclosed herein.

Consider a scenario, in which the gallery application of the electronic device 100 displays the image in a detail view. The user may need to find the particular image stored in the electronic device 100. Further, the user performs the gesture 120 (e.g., scroll gesture in the right side direction) on the gallery application as shown in the FIGS. 15A-15B. The electronic device 100 detects the gesture 120 performed on the content of the gallery application.

Based on the detected gesture 120, the electronic device 100 determines that the user reaches the end of the images in the gallery application. In response to the determination, the electronic device 100 determines the context the associated with the based on the scrolling pattern of the content. The context can be, for example, but not limited to, the image in detail view, the gallery application, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130l and displays the visual cue 130l in the direction of scrolling of the content (e.g., right side of gallery application) of the display 110 as shown in the FIG. 15C. For example, the visual cue 130l provide a portion of the display including various items (e.g., albums, camera, Instagram, trip, etc.). Further, the user can view the specific item by using drop down menu or filter options. This improves the user experience in finding the particular image on the gallery application.

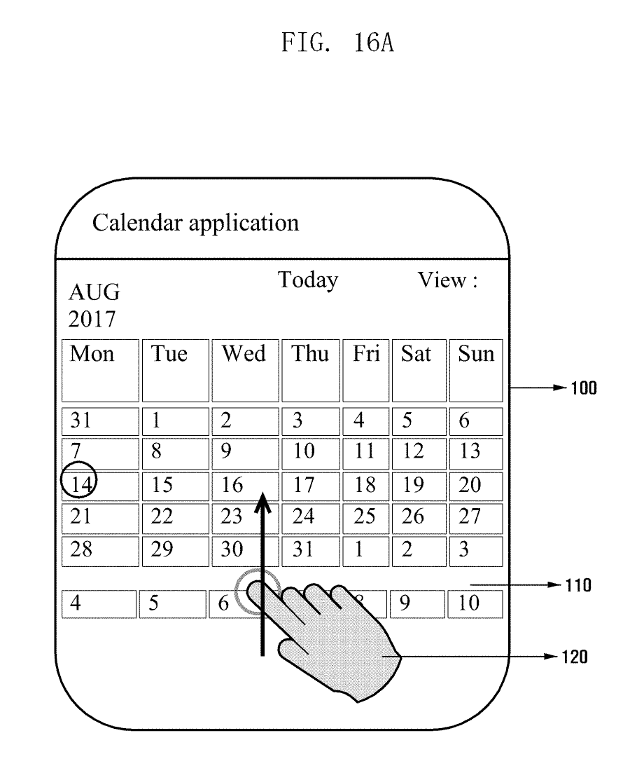

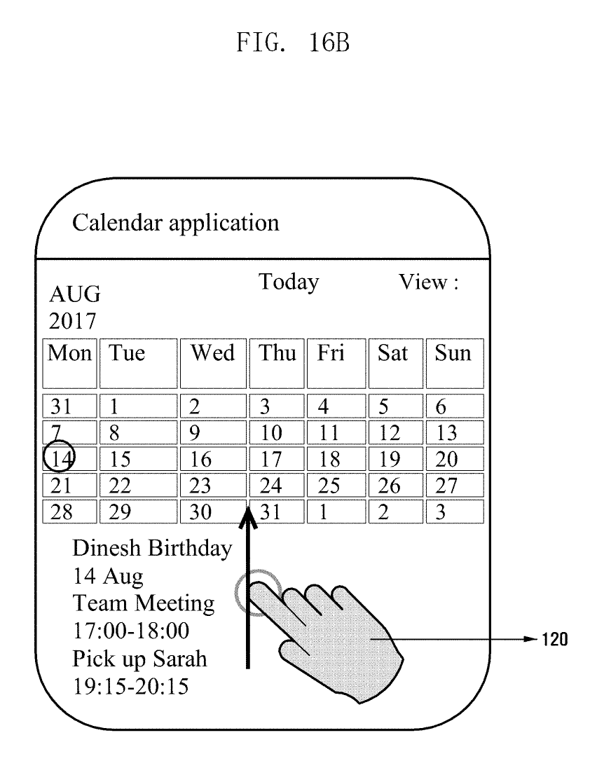

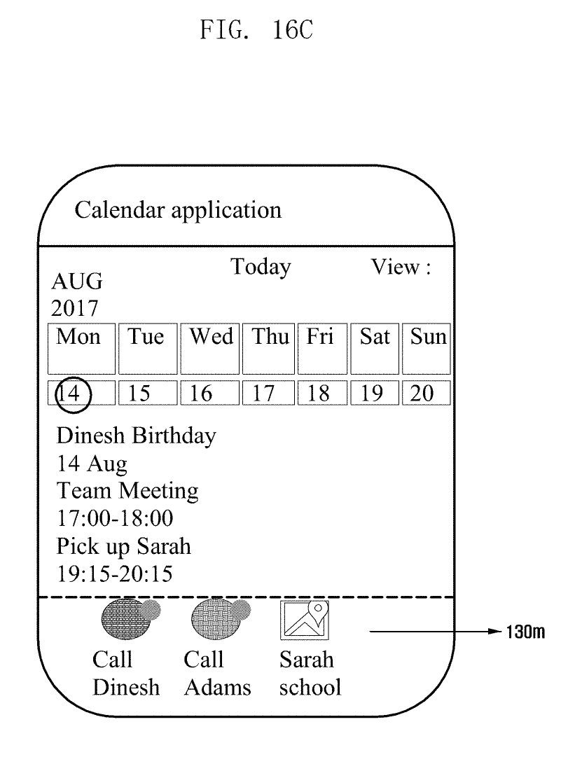

FIGS. 16A-16C illustrate examples in which the visual cue is displayed in the direction of scrolling of the content in the calendar application executed in the electronic device 100, based on determining the usage history of the content on the calendar application, according to an embodiment as disclosed herein.

Consider a scenario, in which the calendar application is currently opened on the display 110 of the electronic device 100. The user performs the gesture 120 (e.g., scroll gesture) on the calendar application currently displayed on the display 110 as shown in the FIGS. 16A-16B. The electronic device 100 detects the gesture 120 performed on the content of the calendar application.

Based on the detected gesture 120, the electronic device 100 determines that the user reaches the end of the content displayed on the calendar application. In response to the determination, the electronic device 100 determines the context the associated with the content on the calendar application based on the scrolling pattern of the content. The context can be for example but not limited to the calendar application, saved events and tasks associated with the calendar application such as contacts, location, time, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130m and displays the visual cue 130m in the direction of scrolling of the content (e.g., at the end of the calendar application) as shown in the FIG. 16C. For example, the visual cue 130m includes displaying other application (e.g., call application for calling Dinesh and Adams based on the frequent actions or display map for locating the user) at the end of the calendar application. This improves the user experience in performing the actions in the calendar application of the electronic device 100.

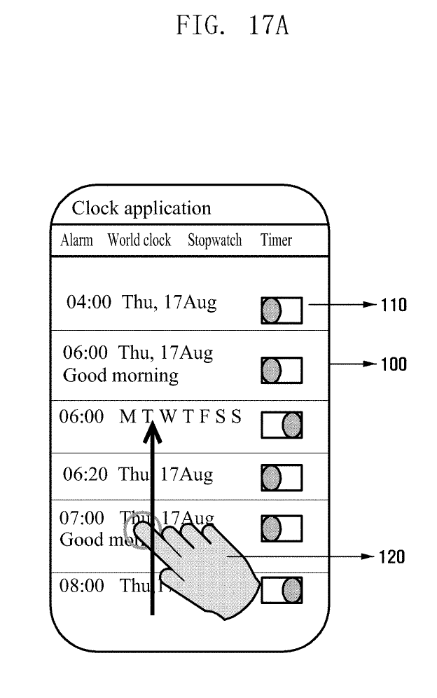

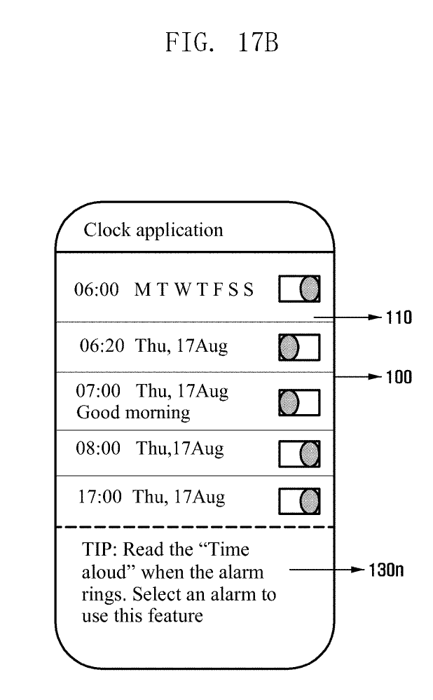

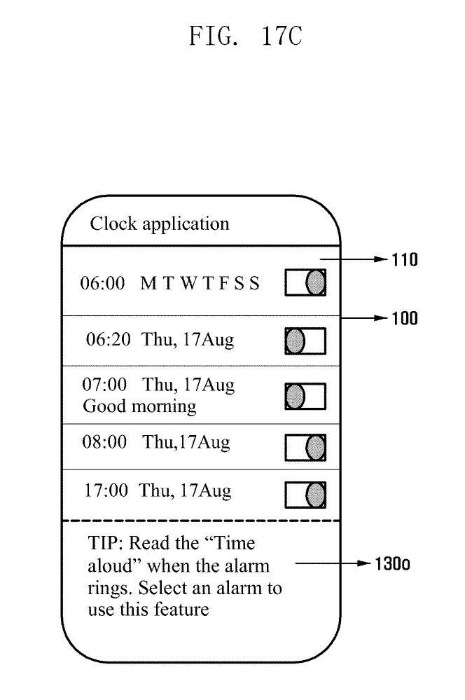

FIGS. 17A-17C illustrate examples in which the visual cue is displayed at the end of the content in the clock application executed in the electronic device 100, based on detecting that the user reaches the end of the content on the clock application, according to an embodiment as disclosed herein.

Consider a scenario, in which the clock application is currently opened on the display 110. The user may need to perform actions (e.g., setting new alarm, volume level for the alarm) in the clock application. Further, the user performs the gesture 120 (e.g., scroll gesture) on the clock application currently displayed on the display 110 as shown in the FIG. 17A. The electronic device 100 detects the gesture 120 performed on the content on the clock application.

Based on the detected gesture 120, the electronic device 100 determines that the user reaches the end of the content displayed on the clock application. In response to the determination, the electronic device 100 determines the context the associated with the content on the clock application based on the scrolling pattern of the content. The context can be for example but not limited to the clock application, a current page of the clock application (such as an alarm, a world clock, a timer, a stopwatch, or the like), details of items saved in clock application, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue (130n-130o) and displays the visual cue (130n-130o) in the direction of scrolling of the content (i.e., at the end of the calendar application) as shown in the FIGS. 17B and 17C. The visual cue (130n-130o) includes setting new alarm and setting volume level for the alarm. For example, the visual cue 130n includes the message saying that ‘read a time aloud when the alarm rings’ and the visual 130o can be the message saying that ‘set alarm at 7 am tomorrow’. This improves the user experience in performing the action in the clock application of the electronic device 100.

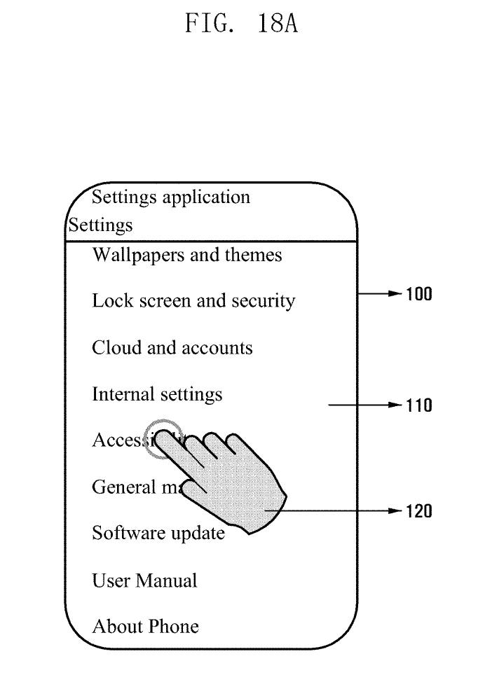

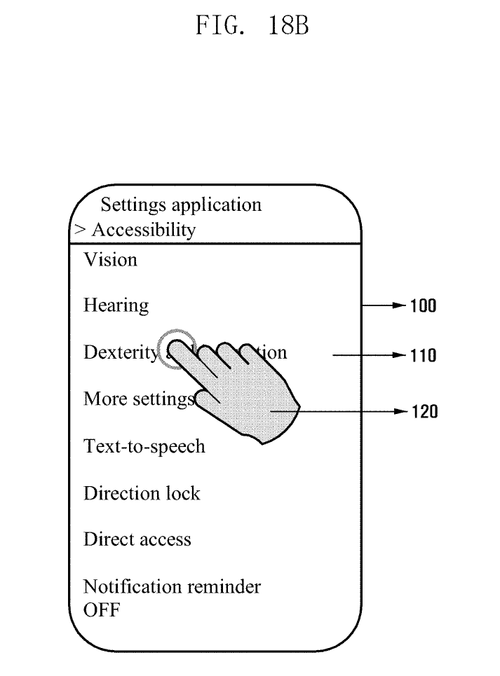

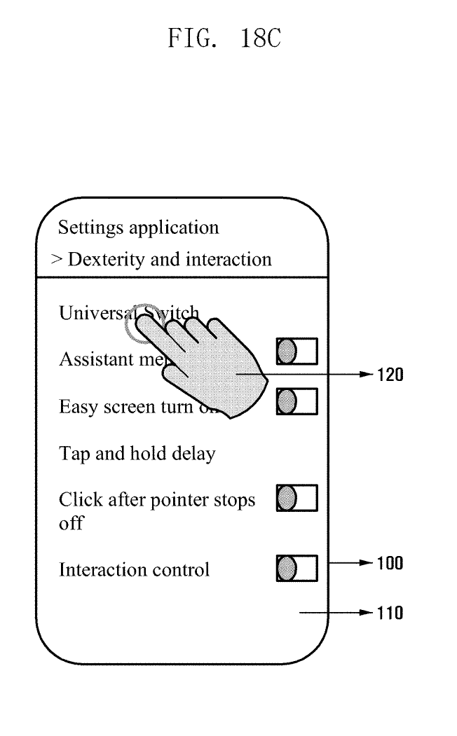

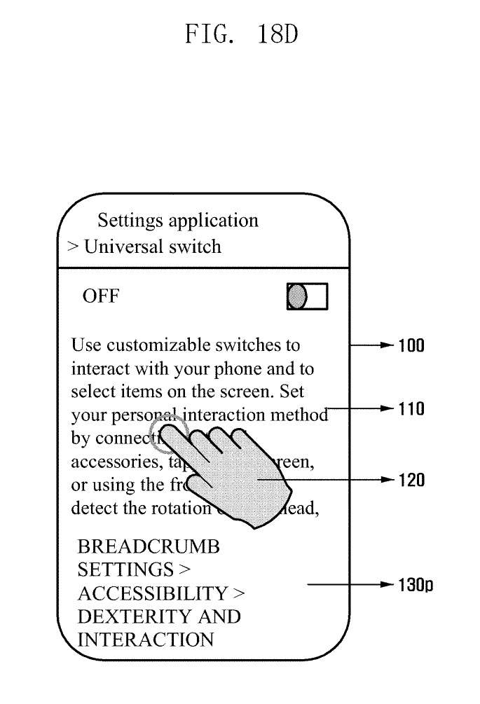

FIGS. 18A-18D illustrate examples in which the visual cue is displayed at the end of the content on the settings application executed in the electronic device 100, based on detecting that the user reaches the end of the settings application, according to an embodiment as disclosed herein.

Consider a scenario, in which the settings application is currently displayed on the display 110. If the user wishes to navigate within the settings application then, the user performs the gesture 120 (e.g., touch gesture) on the settings application currently displayed on the display 110. As shown in the FIG. 18A, the user is currently viewing the settings application and performs the gesture 120 on a tab (e.g., accessibility tab). As shown in the FIG. 18B, the user is switched to the accessibility tab and further performs gesture 120 on the tab (e.g., dexterity and interaction tab). As shown in the FIG. 18C, the user is switched to the dexterity and interaction tab and further performs gesture 120 on the tab (e.g., universal switch tab). As shown in the FIG. 18D, the user is switched to universal switch tab and further performs gesture 120 on the content displayed on the tab (e.g., Universal switch). The electronic device 100 detects the gesture 120 performed on the content on the settings application.

Based on the detected gesture 120, the electronic device 100 determines that the user reaches the end of the content displayed on the settings application. In response to the determination, the electronic device 100 determines the context the associated with the content on the settings application based on the scrolling pattern of the content. The context can be for example but not limited to the settings application, a current tab, the content in the current tab, etc. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130p and displays the visual cue 130p in the direction of scrolling of the content (i.e., at the end of the settings application) as shown in the FIG. 18D. The visual cue 130p includes the breadcrumbs for the performed navigation. For example, the visual cue 130p can be the message includes Settings>Accessibility>Dexterity and Interaction. This improves the user experience in knowing the breadcrumbs on the settings application.

The above scenario is also applicable that the user is about to reach the end of the settings application.

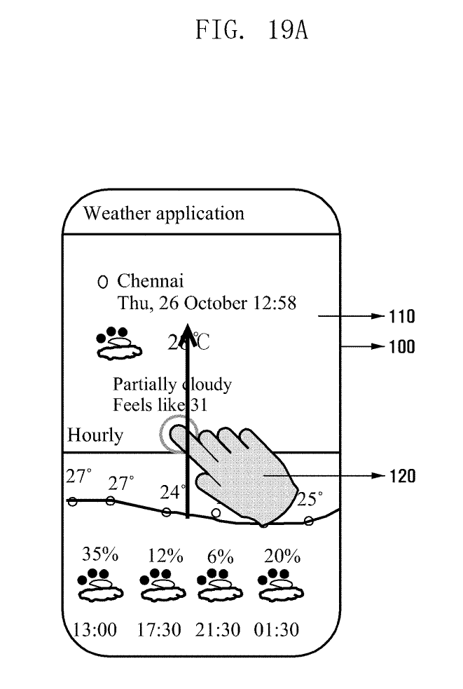

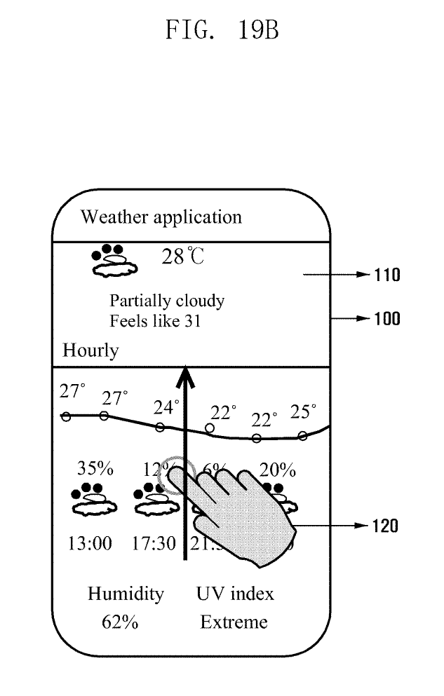

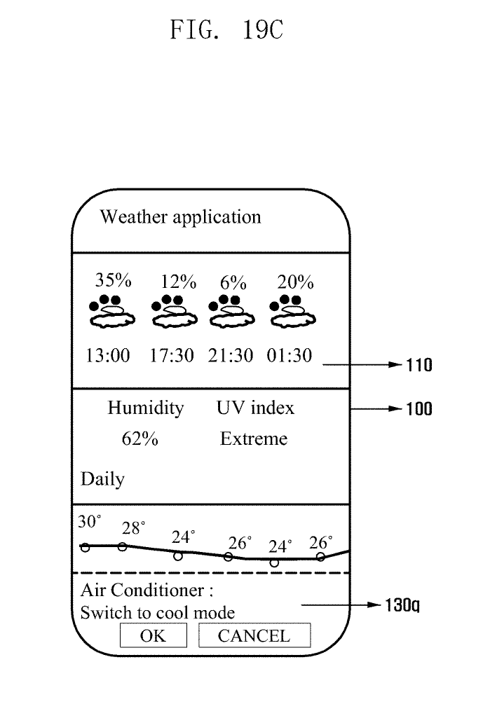

FIGS. 19A-19C illustrate examples in which visual cue is displayed at the end of the content on the weather application executed in the electronic device 100, based on detecting that the user reaches the end of the weather application, according to an embodiment as disclosed herein.

Consider a scenario, in which the weather application is currently displayed on the display 110 of the electronic device 100. The user may need to control a plurality of Internet of Things (IoT) devices which are connected with the electronic device 100. Further, the user performs the gesture 120 (e.g., scroll gesture) on the weather application currently displayed on the display 110 as shown in the FIG. 19A. The electronic device 100 detects the gesture 120 performed on the content on the weather application.

Based on the detected gesture 120, the electronic device 100 determines that the user reaches the end of the content displayed on the weather application as shown in FIG. 19B. In response to the determination, the electronic device 100 determines the context the associated with the content on the weather application based on the scrolling pattern of the content. The context can be for example but not limited to the weather application, the IoT devices. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130q displays the visual cue 130q in the direction of scrolling of the content (i.e., at the end of the weather application) as shown in the FIG. 19C. The visual cue 130q includes a control information for the IoT device, where the control information is related with the weather application as shown in the FIG. 19C. For example, the control information includes a message saying that ‘air conditioner: switch into a cool mode’. This improves the user experience in controlling the IoT device (e.g., Air conditioner) via the electronic device 100.

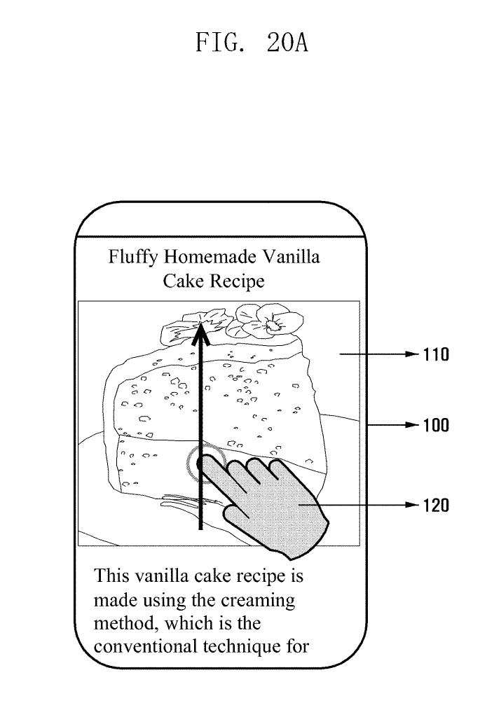

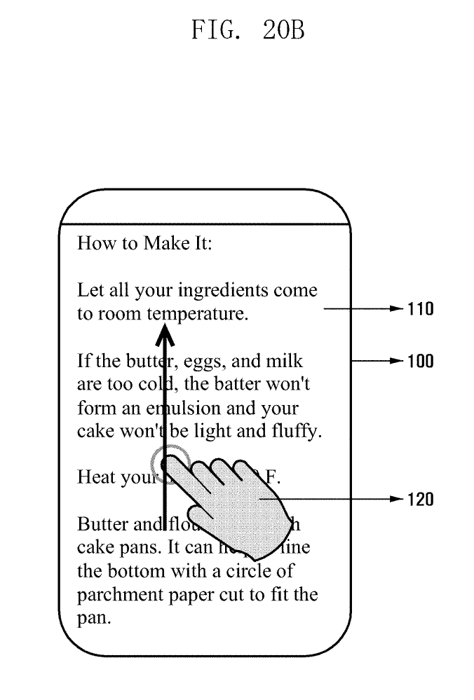

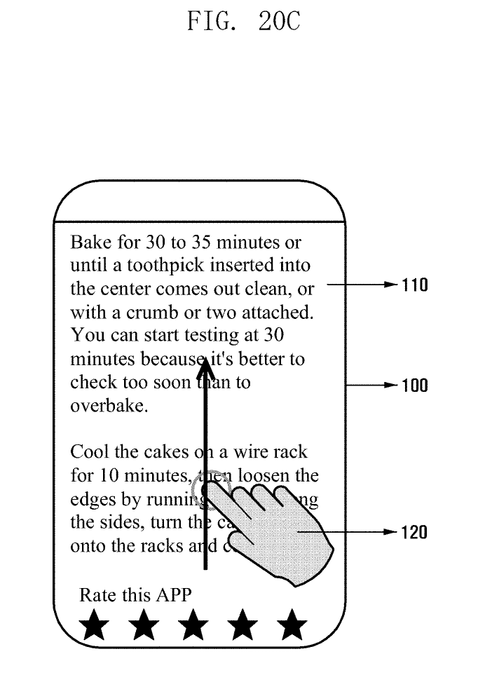

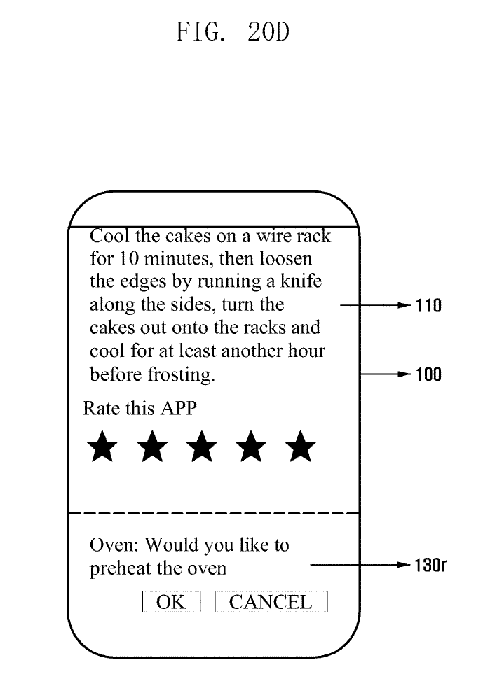

FIGS. 20A-20D illustrate examples in which the visual cue is displayed at the end of the content on the web browser application executed in the electronic device 100, based on detecting that the user reaches the end of the web browser application, according to an embodiment as disclosed herein;

Consider a scenario, in which the webpage (e.g. article relating to cooking) is currently browed on the web browser application executed in the electronic device 100. The user may need to control the plurality of Internet of Things (IoT) devices which are connected with the electronic device 100. Further, the user performs the gesture 120 (e.g., scroll gesture) on the webpage currently displayed on the display 110 as shown in the FIG. 20A. The electronic device 100 detects the gesture 120 performed on the content of the web browser application.

Based on the detected gesture 120, the electronic device 100 determines that the user reaches the end of the content displayed on the webpage) as shown in FIGS. 20B and 20C. In response to the determination, the electronic device 100 determines the context the associated with the content on the webpage based on the scrolling pattern. The context can be for example but not limited to the content associated with the webpage, IoT devices. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130q and displays the visual cue 130r in the direction of scrolling of the content (e.g., at the end of the web browser application) as shown in the FIG. 20D. The visual cue 130q includes the control information for the IoT device, where the control information is related to the webpage content displayed on the web browser application as shown in the FIG. 20D. For example, visual cue 130r includes the message saying that ‘oven: would you like to preheat the oven’. This improves the user experience in controlling the IoT device (e.g., an oven) via the electronic device 100.

FIG. 21A and FIG. 21B illustrate examples in which the visual cue is displayed in the direction of scrolling of the content in the video application executed in the electronic device 100, based on detecting a temporary stop on the content in the video application, according to an embodiment as disclosed herein.

Consider a scenario, in which the video application is currently displayed on the display of the electronic device 100. The video application provides a Virtual Reality (VR) content on the display 110. Further, the user performs the gesture 120 (e.g., touch gesture) on action buttons provided over the VR content. As shown in the FIG. 21A, the user performs the gesture 120 on the action button (e.g., stop button, pause button or the like) on the display 110. The electronic device 100 detects the gesture 120 performed on the action button of the video application.

Based on the detected gesture 120, the electronic device 100 determines that the user pressed a stop button on the VR content displayed in the video application as shown in FIG. 21A. In response to the determination, the electronic device 100 determines the context the associated with the content on the display 110 based on the scrolling pattern of the content. The context can be for example but not limited to the VR content, type of the action buttons, the video application. The scrolling pattern can be for example but not limited to the to-and-fro scrolling, the continuous scrolling in one direction, the slow down or halt scrolling, or the like. The electronic device 100 can be configured to detect the direction of scrolling of the content.

Based on the context associated with the content and direction of scrolling of the content, the electronic device 100 generates the visual cue 130s and displays the visual cue 130s in the direction of scrolling of the content of the display 110 as shown in the FIG. 21B. This improves the user experience in viewing a related suggestions for the animated images in the display 110 of the electronic device 100.

The embodiments disclosed herein can be implemented through at least one software program running on at least one hardware device and performing network management functions to control the elements. The elements shown in the FIGS. 1A through 21B include blocks which can be at least one of a hardware device, or a combination of hardware device and software module.

Although the present disclosure has been described with various embodiments, various changes and modifications may be suggested to one skilled in the art. It is intended that the present disclosure encompass such changes and modifications as fall within the scope of the appended claims.

What is claimed is:

1. A method of an electronic device, comprising:
displaying at least one content on a display of the electronic device;
determining a scrolling pattern of the at least one content when the at least one content is scrolled;
identifying context information of the at least one content based on the scrolling pattern;
detecting an end of a content among the at least one content where the content is no longer scrollable; and
displaying a visual cue based on the context information of the at least one content.

2. The method of claim 1, wherein detecting the end of the content among the at least one content indicates at least one of:
an end of the content in at least one application is reached while the content is scrolled,
an end of the content in the at least one application is about to be reached while the content is scrolled, or
a temporary stop on at least one portion of the content while the content is scrolled.

3. The method of claim 1, wherein the visual cue comprises a recommendation of at least one element corresponding to the at least one content, wherein the at least one element is contextually related to the at least one content.

4. The method of claim 3, wherein the at least one element is operable for at least one of:
dynamically filtering the at least one content, wherein the at least one content is content of at least one application,
dynamically associating at least one portion of the at least one content of the at least one application with another application in the electronic device, or
dynamically operating another application in the electronic device.

5. The method of claim 1, wherein determining the scrolling pattern of the at least one content comprises:
determining the scrolling pattern of the at least one content, wherein the at least one content is content of at least one application, based on:
at least one of an interaction pattern from a user input with at least one portion of the at least one content while the content is scrolled,
an interaction pattern of the at least one content of the at least one application,
a switching pattern between the at least one application and at least one other application in the electronic device, or
a context of the at least one application; and
wherein identifying the context information of the at least one content comprises determining the context information of the at least one content of the at least one application based on the scrolling pattern.

6. The method of claim 5, wherein the interaction pattern is dynamically determined based on:
a speed of scrolling the at least one content,
a time spent for displaying on the at least one portion of the at least one content while the at least one content is scrolled, or
a filter used while the at least one content is scrolled.

7. The method of claim 5, wherein the switching pattern is dynamically determined based on:
a type of action from the user input for the at least one portion of the at least one content while the at least one content is scrolled,
another application running on the electronic device, or
a user intent.

8. The method of claim 5, wherein the context of the at least one application is determined by:
determining a domain of the at least one application, features supported by the at least one application, linked apps with the at least one application, the content supported by the at least one application, a user intent associated with the at least one application, or a user interaction pattern with the at least one application; and
determining the context of the at least one application based on the domain of the at least one application, features supported by the at least one application, linked apps with the at least one application, a content supported by the at least one application, or a user intent associated with the at least one application.

9. The method of claim 1, wherein displaying the visual cue based on the context information of the at least one content comprises:
detecting a direction of the scrolling of the at least one content; and
displaying the visual cue in the direction of the scrolling of the at least one content.

10. The method of claim 1, wherein a user interface of the visual cue is displayed in a portion of a user interface of at least one application corresponding to a position of the at least one content at which the end of the content among the at least one content is detected.

11. An electronic device, comprising:
a display;
at least one processor; and
a memory configured to store instructions that, when executed by the at least one processor, cause the electronic device to:
control the display to display at least one content,
determine a scrolling pattern of the at least one content when the at least one content is scrolled,
identify context information of the at least one content based on the scrolling pattern,
detect an end of a content among the at least one content where the content is no longer scrollable, and
control the display to display a visual cue based on the context information of the at least one content.

12. The electronic device of claim 11, wherein detecting the end of the content among the at least one content indicates at least one of:
an end of the content in at least one application is reached while the content is scrolled,
an end of the content in the at least one application is about to be reached while the content is scrolled, or
a temporary stop on at least one portion of the content while the content is scrolled.

13. The electronic device of claim 11, wherein the visual cue comprises a recommendation of at least one element corresponding to the at least one content, wherein the at least one element is contextually related to the at least one content.

14. The electronic device of claim 13, wherein the at least one element is operable for at least one of:
dynamically filtering the at least one content, wherein the at least one content is content of at least one application,
dynamically associating at least one portion of the at least one content of the at least one application with another application in the electronic device, or
dynamically operating another application in the electronic device.

15. The electronic device of claim 11, wherein determining the scrolling pattern of the at least one content comprises:
determining the scrolling pattern of the at least one content, wherein the at least one content is content of at least one application, based on:
at least one of an interaction pattern from a user input with at least one portion of the at least one content while the content is scrolled,
an interaction pattern of the at least one content of the at least one application,
a switching pattern between the at least one application and at least one other application in the electronic device, or
a context of the at least one application; and
wherein identifying the context information of the at least one content comprises determining the context information of the at least one content of the at least one application based on the scrolling pattern.

16. The electronic device of claim 15, wherein the interaction pattern is dynamically determined based on:
a speed of scrolling the at least one content,
a time spent for displaying on the at least one portion of the at least one content while the at least one content is scrolled, or
a filter used while the at least one content is scrolled.

17. The electronic device of claim 15, wherein the switching pattern is dynamically determined based on:
a type of action from the user input for the at least one portion of the at least one content while the at least one content is scrolled,
another application running on the electronic device, or
a user intent.

18. The electronic device of claim 15, wherein the context of the at least one application is determined by:
determining a domain of the at least one application, features supported by the at least one application, linked apps with the at least one application, the content supported by the at least one application, a user intent associated with the at least one application, or a user interaction pattern with the at least one application; and
determining the context of the at least one application based on the domain of the at least one application, features supported by the at least one application, linked apps with the at least one application, a content supported by the at least one application, or a user intent associated with the at least one application.

19. The electronic device of claim 11, wherein displaying the visual cue based on the context information of the at least one content comprises:
detecting a direction of the scrolling of the at least one content; and
displaying the visual cue in the direction of the scrolling of the at least one content.

20. The electronic device of claim 11, wherein a user interface of the visual cue is displayed in a portion of a user interface of at least one application corresponding to a position of the at least one content at which the end of the content among the at least one content is detected.
